(19) United States
(12) Patent Application Publication
(10) Pub. No.: US 2024/0257545 A1
(43) Pub. Date: Aug. 1, 2024

(54) INFORMATION PROCESSING SYSTEM, ITEM VALUE EXTRACTION METHOD, AND MODEL GENERATION METHOD

(71) Applicant: PFU LIMITED, Ishikawa (JP)

(72) Inventor: Katsuhito SHIMAZAKI, Ishikawa (JP)

(21) Appl. No.: 18/633,099

(22) Filed: Apr. 11, 2024

Related U.S. Application Data
(63) Continuation of application No. PCT/JP2021/038147, filed on Oct. 14, 2021.

(51) Int. Cl. G06V 30/18

(52) U.S. Cl. CPC G06V 30/18

(57) ABSTRACT

An information processing system includes circuitry that: acquires a character recognition result that is a result of character recognition performed on a target image; extracts, from the character recognition result of the target image, a plurality of candidate character strings that are candidates of an item value of an extraction target item; generates, for each of the plurality of candidate character strings, a feature quantity based on positional relationships between the candidate character string and a plurality of item keywords in the target image, the plurality of item keywords being keyword word strings for use in extraction of the item value of the extraction target item; stores a trained model in a memory; and inputs the feature quantity of each of the plurality of candidate character strings in the target image to the trained model so as to extract the item value of the extraction target item.

### CROSS-REFERENCE TO RELATED APPLICATIONS

This patent application is a continuation application of International Application No. PCT/JP2021/038147, filed on Oct. 14, 2021, in the Japan Patent Office, the entire disclosure of which is hereby incorporated by reference herein.

### BACKGROUND

### Technical Field

The present disclosure relates to an information processing system, an item value extraction method, and a model generation method.

### Related Art

In the related art, a method for generating an extraction rule has been proposed. In the method, an extraction target area is designated in a document image. A text area including an extraction term is extracted from an area near the extraction target area, and is set as an item name candidate area. Based on the extraction target area and the item name candidate area, an extraction rule is generated. If there is a single item name candidate area, the item name candidate area is set as an item name area, and an extraction rule is generated based on a positional relationship between the extraction target area and the item name area. If there are multiple item name candidate areas and a single item name area is successfully identified from the multiple item name candidate areas, an extraction rule is generated based on a positional relationship between the extraction target area and the item name area successfully identified.

In addition, a method for determining an item value has been proposed. In the method, an item value notation score is calculated for a character string detected and recognized from a form image. Then, for an arrangement relationship of a pair of item value candidates, an item value candidate arrangement score is calculated which represents appropriateness as an arrangement relationship between item values of different attributes. Based on values of item value candidate scores and the item value candidate arrangement score, an item value candidate pair score is calculated which represents appropriateness as a pair of item values of different attributes. An item value of an item value group is thus determined.

Further, a method has been proposed which includes determining at least one possible target value with use of at least one scoring application that uses information from at least one training document, and applying the information to at least one new document with use of the at least one scoring application in order to determine at least one value of at least one target in the at least one new document.

### SUMMARY

According to an embodiment of the present disclosure, an information processing system includes circuitry. The circuitry acquires a character recognition result that is a result of character recognition performed on a target image. The circuitry extracts, from the character recognition result of the target image, a plurality of candidate character strings that are candidates of an item value of an extraction target item. The circuitry generates, for each of the plurality of candidate character strings, a feature quantity based on positional relationships between the candidate character string and a plurality of item keywords in the target image, the plurality of item keywords being keyword word strings for use in extraction of the item value of the extraction target item. The circuitry stores a trained model in a memory, the trained model being generated through machine learning such that, in response to input of a feature quantity based on positional relationships between a character string and the plurality of item keywords in an image, information indicating appropriateness of the character string being the item value of the extraction target item is output. The circuitry inputs the feature quantity of each of the plurality of candidate character strings in the target image to the trained model so as to extract the item value of the extraction target item from among the plurality of candidate character strings.

According to an embodiment of the present disclosure, an information processing system includes circuitry. The circuitry acquires a character recognition result that is a result of character recognition performed on a plurality of training images of documents having layouts different from one another. The circuitry generates, for each of character strings included in each of the plurality of training images, the character strings including a character string that is an item value of an extraction target item and other character strings, a feature quantity based on positional relationships between the character string and a plurality of item keywords in the training image, the plurality of item keywords being keyword word strings for use in extraction of the item value of the extraction target item. The circuitry generates a trained model through machine learning, the machine learning being performed using training data that associates, for each of the character strings included in each of the plurality of training images, the feature quantity of the character string with information indicating whether the character string is the item value of the extraction target item.

According to an embodiment of the present disclosure, an item value extraction method includes acquiring a character recognition result that is a result of character recognition performed on a target image; extracting, from the character recognition result of the target image, a plurality of candidate character strings that are candidates of an item value of an extraction target item; generating, for each of the plurality of candidate character strings, a feature quantity based on positional relationships between the candidate character string and a plurality of item keywords in the target image, the plurality of item keywords being keyword word strings for use in extraction of the item value of the extraction target item; storing a trained model in a memory, the trained model being generated through machine learning such that, in response to input of a feature quantity based on positional relationships between a character string and the plurality of item keywords in an image, information indicating appropriateness of the character string being the item value of the extraction target item is output; and inputting the feature quantity of each of the plurality of candidate character strings in the target image to the trained model so as to extract the item value of the extraction target item from among the plurality of candidate character strings.

According to an embodiment of the present disclosure, a model generation method includes acquiring a character recognition result that is a result of character recognition performed on a plurality of training images of documents having layouts different from one another; generating, for each of character strings included in each of the plurality of training images, the character strings including a character string that is an item value of an extraction target item and other character strings, a feature quantity based on positional relationships between the character string and a plurality of item keywords in the training image, the plurality of item keywords being keyword word strings for use in extraction of the item value of the extraction target item; and generating a trained model through machine learning, the machine learning being performed using training data that associates, for each of the character strings included in each of the plurality of training images, the feature quantity of the character string with information indicating whether the character string is the item value of the extraction target item.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of an information processing system according to an embodiment of the present disclosure;

FIG. 2 is a schematic diagram illustrating a functional configuration of a training apparatus according to the embodiment;

FIG. 3 is a diagram illustrating an extraction example of item value candidates (in a first training image) according to the embodiment;

FIG. 4 is a diagram illustrating an extraction example of item value candidates (in a second training image) according to the embodiment;

FIG. 5 is a diagram illustrating an example of a ground truth definition table according to the embodiment;

FIG. 6 is a diagram illustrating a calculation example of a direction weight according to the embodiment;

FIGS. 7A and 7B are diagrams illustrating a calculation example of a distance weight and a direction weight in the first training image according to the embodiment;

FIGS. 8A and 8B are diagrams illustrating a calculation example of a distance weight and a direction weight in the second training image according to the embodiment;

FIG. 9 is a diagram illustrating a calculation example of an effectiveness score according to the embodiment;

FIG. 10 is a diagram illustrating an extraction example of positional relationship information in the first training image according to the embodiment;

FIG. 11 is a diagram illustrating an example of a positional relationship information list in a training process according to the embodiment;

FIG. 12 is a diagram illustrating an example of a feature list in the training process according to the embodiment;

FIG. 13 is a schematic diagram illustrating a functional configuration of an information processing apparatus according to the embodiment;

FIG. 14 is a diagram illustrating an example of a positional relationship information list and appropriateness scores for an extraction target image according to the embodiment;

FIG. 15 is a flowchart illustrating an overview of a flow of the training process according to the embodiment;

FIG. 16 is a flowchart illustrating an overview of a flow of an item keyword determination process according to the embodiment;

FIG. 17 is a flowchart illustrating an overview of a flow of a trained model generation process according to the embodiment;

FIG. 18 is a flowchart illustrating an overview of a flow of an extraction process according to the embodiment;

FIG. 19 is a diagram illustrating an overview of a functional configuration of a training apparatus according to another embodiment of the present disclosure;

FIG. 20 is a diagram illustrating an example of a ground truth definition generation screen (when “billing amount” is selected) according to the other embodiment;

FIG. 21 is a diagram illustrating an example of the ground truth definition generation screen (when “payment deadline” is selected) according to the other embodiment; and

FIG. 22 is a flowchart illustrating an overview of a flow of a ground truth definition generation process according to the other embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Techniques of extracting information (item values) written in a document proposed in the related art include a technique of applying optical character recognition (OCR) to extract item values from a fixed-format form. In a fixed-format document such as a fixed-format form, written positions (layout) of items are fixed. Thus, OCR read positions are defined for the items in advance, so that desired information (item values) is successfully extracted.

However, in the case of documents of the same kind having various layouts (formats), since the layout varies from document to document, it is laborious to define the OCR read positions for each layout in advance. This makes it difficult to extract item values with the above-described method of the related art.

An information processing system, method, and program according to embodiments of the present disclosure will be described below with reference to the accompanying drawings. The embodiments described below are illustratively present embodiments and do not limit the information processing system, method, and program disclosed herein to a specific configuration described below. In the implementation, specific configurations may be adopted appropriately according to the mode of implementation, and various improvements and modifications may be made.

Herein, description will be given of embodiments in which the information processing system, method, and program disclosed herein are implemented in a system that extracts an item value from a form image. However, the information processing system, method, and program disclosed herein are widely used for a technique of extracting an item value from a document image, and the target to which the present disclosure is applied is not limited to the examples presented in the embodiments.

### System Configuration

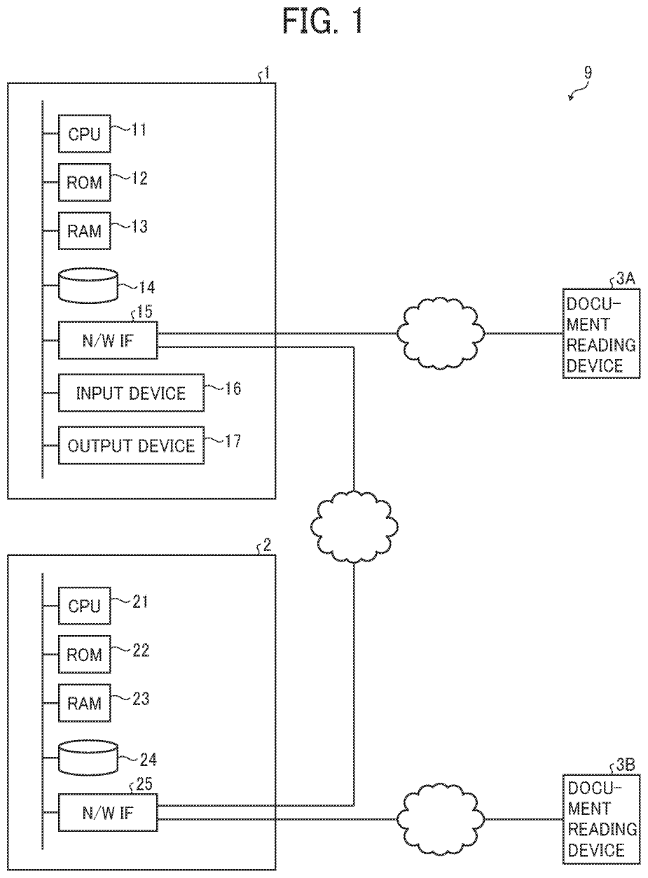

FIG. 1 is a schematic diagram illustrating a configuration of an information processing system 9 according to an embodiment of the present disclosure. The information processing system 9 includes one or more information processing apparatuses 1, a training apparatus 2, and document reading devices 3 (3A and 3B) that are connected to and communicate with one another via a network. The training apparatus 2 generates a trained model for extracting item values of extraction target items (item attributes) in a document. The information processing apparatus 1 uses the trained model generated in the training apparatus 2 to extract item values of extraction target items included in a target image.

A form is presented as an example of the document in the present embodiment but the document may be any document including items (item values), other than the form. Note that in the present embodiment, the term “form” refers to a form of broad sense including an accounting ledger, a slip, and an evidenced document. In addition, the term “form” may refer not only to forms (semi-fixed-format forms) of the same kind having different layouts for different documents but also to forms (fixed-format forms) having prefixed layouts.

In the present embodiment, the term “item value” refers to a value corresponding to an item (item attribute) and information (character string) input (written) for a target item. For example, the item value is a numerical value character string such as “12,800” or “7,340” if the item is “billing amount” and is a date character string such as “Aug. 2, 2021” or “3/5/2022” if the item is “payment deadline”.

The term “item name” refers to a name that is assigned to the item and written in the document (original). For example, the item name such as “amount billed”, “total”, or “billing total” is written if the item (item attribute) is the billing amount, and the item name such as “payment date”, “transfer deadline”, or “payment due date” is written if the item (item attribute) is the payment deadline. In a document having an unfixed layout, the item name and the written position of the item name for the same item may differ depending on the original (such as an issuing company).

The term “item attribute” refers to an attribute defined to uniformly treat a plurality of items that indicates the same concept but may be assigned item names different from one another irrespectively of the item names actually assigned in documents. A user may assign (determine) any name to (for) the item attribute. For example, the item attribute “billing amount” is determined for the items assigned the item names such as “amount billed”, “total”, and “billing total”, and the item attribute “payment deadline” is determined for the items assigned the item names such as “payment date”, “transfer deadline”, and “payment due date”.

As described above, the item name may differ depending on the document but the item attribute is a name (attribute) that is usable in common in all documents. Note that in the present embodiment, the term “extraction target item” is synonymous with the term “extraction target item attribute”.

The term “item keyword” refers to a word string that is written in a document (original) and includes an item name, and is a word string (keyword word string) serves as a marker for extracting information (item value) desired to be extracted. The item keyword may include, in addition to the item name directly related to the item value, the item name less related to the item name and a word string other than the item name.

The information processing apparatus 1 is a computer including a central processing unit (CPU) 11, a read-only memory (ROM) 12, a random access memory (RAM) 13, a storage device 14 such as an electrically erasable and programmable read-only memory (EEPROM) or a hard disk drive (HDD), a communication unit (N/W IF) 15 such as a network interface card, an input device 16 such as a keyboard or a touch panel, and an output device 17 such as a display. Regarding the specific hardware configuration of the information processing apparatus 1, any component may be omitted, replaced, or added as appropriate according to a mode of implementation. Further, the information processing apparatus 1 is not limited to an apparatus having a single housing. The information processing apparatus 1 may be implemented by multiple apparatuses using, for example, a so-called cloud or distributed computing technology.

The information processing apparatus 1 acquires a trained model and an item keyword list from the training apparatus 2 and stores the trained model and the item keyword list therein. The trained model and the item keyword list are used for extracting an item value of an extraction target item in a document (original) of a predetermined document type which is a document type from which the item value is extracted. The information processing apparatus 1 also acquires an image (extraction target image) of a document (original) of the predetermined document type from the document reading device 3A. The information processing apparatus 1 uses the trained model and the item keyword list to extract an item value of an extraction target item from the extraction target image. The document type (predetermined document type) from which the item value is extracted may be various document types such as an invoice, a purchase order, a delivery slip, a slip, and an expense book.

Note that the document image is not limited to electronic data (image data) in Tagged Image File Format (TIFF), Joint Photographic Experts Group (JPEG), or Portable Network Graphics (PNG) and may be electronic data in Portable Document Format (PDF). Thus, the document image may be electronic data (PDF file) obtained through scanning and conversion of the original into a PDF file or electronic data initially created as a PDF file.

Note that the method of acquiring the extraction target image is not limited to the example described above, and any method such as a method of acquiring the extraction target image via another apparatus or a method of acquiring the extraction target image by reading the corresponding data from the storage device 14 or external recording media such as a Universal Serial Bus (USB) memory, an Secure Digital (SD) memory card, and an optical disk may be used. Note that if the extraction target image is not acquired from the document reading device 3A, the document reading device 3A may be omitted from the information processing system 9. Likewise, the method of acquiring the trained model and the item keyword list is not limited to the example described above, and any method may be used.

The training apparatus 2 is a computer including a CPU 21, a ROM 22, a RAM 23, a storage device 24, and a communication unit (N/W IF) 25. Regarding the specific hardware configuration of the training apparatus 2, any component may be omitted, replaced, or added as appropriate according to a mode of implementation. Further, the training apparatus 2 is not limited to an apparatus having a single housing. The training apparatus 2 may be implemented by multiple apparatuses using, for example, a so-called cloud or distributed computing technology.

The training apparatus 2 acquires document images (training images) of the predetermined document type (for example, invoice) from the document reading device 3B. The training apparatus 2 performs a training process using the training images to generate a trained model and an item keyword list used for extracting an item value of an extraction target item in a document of the predetermined document type.

Note that the method of acquiring the training images is not limited to the example described above, and any method such as a method of acquiring the training images via another apparatus or a method of acquiring the training images by reading the corresponding data from the storage device 24 or an external recording medium may be used. Note that if the training images are not acquired from the document reading device 3B, the document reading device 3B may be omitted from the information processing system 9. In the present embodiment, the information processing apparatus 1 and the training apparatus 2 are illustrated as separate apparatuses (separate housings). However, the configuration is not limited to this example, and the information processing system 9 may include a single device (housing) that performs both the training process and an item value extraction process.

Each of the document reading devices 3 (3A and 3B) is a device that, in response to a scan instruction from a user, optically reads a document of a paper medium to acquire a document image, and is a scanner or a multifunction peripheral, for example. The document reading device 3A reads a form from which the user desires to extract an item value (target form from which an item value is extracted) to acquire an extraction target image. The slip is, for example, an invoice in which data is to be input. The document reading device 3B reads a plurality of forms of the same type (documents of the predetermined document type) having different layouts to acquire a plurality of training images. Note that the document reading devices 3A and 3B may be the same device (in the same housing). The document reading devices 3 are not limited to devices having a function of transmitting an image to another apparatus and may be an image-capturing devices such as a digital camera or a smartphone. The document reading devices 3 may be without the character recognition (OCR) function.

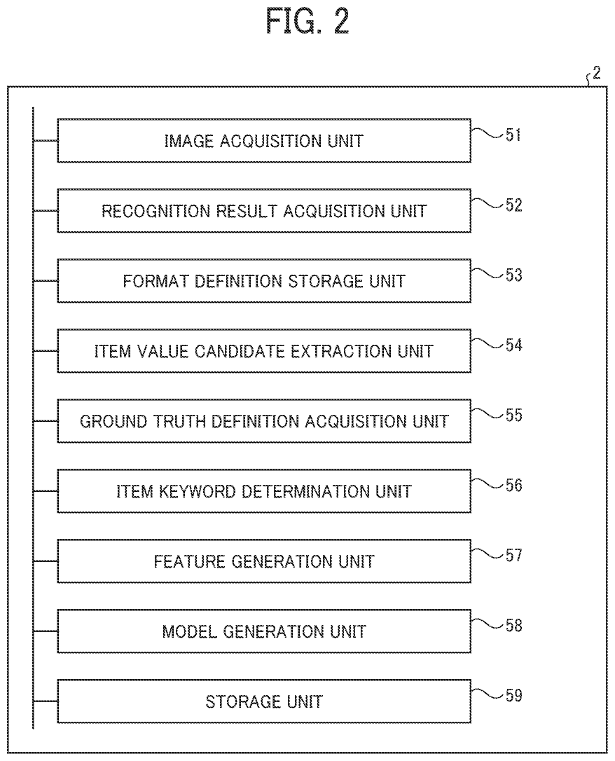

FIG. 2 is a schematic diagram illustrating a functional configuration of the training apparatus according to the present embodiment. The CPU 21 reads a program recorded in the storage device 24 to the RAM 23 and executes the program, so that the pieces of hardware of the training apparatus 2 are controlled. Consequently, the training apparatus 2 functions as an apparatus including an image acquisition unit 51, a recognition result acquisition unit 52, a format definition storage unit 53, an item value candidate extraction unit 54, a ground truth definition acquisition unit 55, an item keyword determination unit 56, a feature generation unit 57, a model generation unit 58, and a storage unit 59. Note that in the present embodiment and other embodiments described below, each of the functions of the training apparatus 2 are executed by the CPU 21 which is a general-purpose processor. However, some or all of these functions may be executed by one or more dedicated processors. Each of the functions of the training apparatus 2 is not limited to a function implemented by an apparatus (single apparatus) having a single housing, and may be implemented remotely and/or in a distributed manner (for example, in cloud).

In the present embodiment, the trained model and the item keyword list for extracting an item value from a target form (form image) based on a relationship between the item value and an item name in a common form (document) are generated. The concept of extracting an item value based on a relationship (positional relationship) between the item value and an item name in a document will be described below.

An item name corresponding to an item value is often written in a left direction or above direction of the item value. An item name corresponding to an item value is often written near the item value. These are a relationship common to both a fixed-format form and a semi-fixed-format form. For example, when the item value of the item “billing amount” (item attribute “billing amount”) is desired to be extracted, the item name such as “total”, “amount billed”, “payment amount”, or “transfer amount” is written on the left side of and near the item value, a related keyword such as “amount” is written above the item value, and related keywords “tax”, “subtotal”, and “discount” are written in an oblique direction of the item value.

This makes it possible to determine, based on a positional relationship between an item value candidate and an item keyword (a word string expected to be related to the item value and located near the item value) written in a left direction or above direction of the item value candidate, appropriateness of the item value candidate being an intended item value (item value of the extraction target item). That is, what item keyword (word strings) is written in a left direction or above direction of an item value (item value candidate) at what distance and in what direction is statistically collected and learned, so that a trained model that determines appropriateness of the item value candidate being the item value of the target item can be generated. In other words, item keywords written near an item value candidate, and directions in which and distances at which the respective item keywords are located are input as features, so that a model that identifies appropriateness of the item value candidate being the item value of the target item can be generated.

The image acquisition unit 51 acquires a plurality of training images (sample images) to be used in a training process. The image acquisition unit 51 acquires, as the training images, a plurality of images (pieces of image data) for documents of the same type having layouts different from one another. When companies or the like that issue forms of invoice or the like differs, positions where items are written in the forms or layouts of item names or the like may differ. Accordingly, for example, a plurality of images of invoices of different issuers are used as the training images. For example, in response to a scan instruction from a user, the document reading device 3B reads a plurality of invoices having layouts different from one another. The image acquisition unit 51 acquires, as the training images, scanned images of the invoices resulting from the reading. Note that the document image (training image) includes information included the document as an image.

Note that the number of training images of each layout may be any number, and one or more training images are used for each layout. The use of a plurality of training images for one layout allows training to be performed at a higher accuracy. For example, if there is an invoice frequently used in business operations (such as an invoice issued by A Corporation), the number of training images for the layout of that invoice may be increased. Such an adjustment in the number of training images in accordance with the frequency (importance) of the layout to be used allows training to be performed in accordance with a user environment.

The recognition result acquisition unit 52 acquires a character recognition result (character string data) of each training image. The recognition result acquisition unit 52 applies OCR and reads the entire training image (entire area), and thus acquires a character recognition result (hereinafter, referred to as “full-text OCR result”) for the training image. Note that the full-text OCR result may have any data structure that includes a character recognition result for each character string (character string image) in the training image. Note that a method of acquiring a full-text OCR result is not limited to the example described above, and any method such as a method of acquiring the full-text OCR result via another apparatus such as a character recognition device that performs an OCR process or a method of acquiring the full-text OCR result by reading the full-text OCR result from an external recording medium or the storage device 24 may be used. Note that in the present embodiment, the term “character string” refers to a string (character sequence) including one or more characters. The characters include hiragana, katakana, kanji, alphabets, numbers, and symbols.

The format definition storage unit 53 stores a format definition of the extraction target item. The format definition of the extraction target item is used in extraction of item value candidates. Specifically, in an item value candidate extraction process, character strings that match the format definition of the extraction target item are extracted as item value candidates of the extraction target item. Accordingly, a character string format related to the extraction target item (a format of a character string that may be the item value of the extraction target item) is defined as the format definition such that possible character strings of the item value of the extraction target item are extracted as the item value candidates. For example, in the case of the item attribute “payment deadline” related to the date, a format related to “date” is defined as the character string format related to “payment deadline” in the format definition of the item attribute “payment deadline”, such that possible character strings of the item value of “payment deadline” are extracted as the item value candidates. For example, in the format definition of the item attribute “billing amount” related to the amount, a format related to “amount” is defined as a character string format related to “billing amount”. Specific examples of the format definition are presented below.

For example,

‘\d{4}[ [symbol] \]\d{1,2}[\/\.\-]\d{1,2}‘\’|\d{4}[ [symbol] ]\d{1,2}[ [symbol] ]\d{1,2}[ [symbol] ]‘\’|(JAN(UARY)?|FEB(LU ARY)?|MAR(CH)?|APR(IL)?|MAY|JUNE?|JULY?|AUG(UST)?|SEP(TEMBER)?|OCT(OBE R)?|NOV(EMBER)?|DEC(EMBER)?|JLY)[\/\.\-]?\d{1,2}(th)?[\,\/\.\-]?(\d{4}|\d{2})’ is defined as the format related to “date” of the format definition of the item attribute “payment deadline”. The format definition of this example enables the date in various notations (formats) to be extracted as item value candidates (candidate character strings) of the item attribute “payment deadline”. The date in various notations (formats) include the date in a notation using slashes “08/09/2020”, the date in a notation using periods “2.17.2021”, the date in a notation using kanji such as “2020 [symbol] 7 [symbol] 24 [symbol] ”, and the date in a notation using English such as “JAN 23, 2020”.

In another example, ‘\d{0,3}[.,]?\d{0,3}[.,]?\d{1,3}[.,]\d{0,3}’ is defined as the format related to “amount” of the format definition of the item attribute “billing amount”. That format definition of this example enables a character string that includes numerals of three digits and a separating character such as a comma or period therebetween to be extracted as item value candidates of the item attribute “billing amount”.

Note that in the present embodiment, the format definition created by the user in advance is exemplified. However, the format definition is not limited to this example, and may be automatically generated based on a ground truth definition (described later). The format definition is not limited to the above-described format definition based on the regular expression, and may be defined by an expression other than the regular expression. The example is presented above in which each extraction target item attribute is associated with the format definition of the item attribute. However, the configuration is not limited to this example, and a plurality of item attributes may be associated with a single format definition. For example, the format (format definition) related to the amount may be associated with the item attribute “billing amount” and the item attribute “unit cost”.

The item value candidate extraction unit 54 extracts a plurality of candidate character strings (item value candidates) which are character strings that can be an item value of an extraction target item from the character recognition result of each training image. The item value candidate extraction unit 54 extracts character strings that match the format definition of an extraction target item, as the item value candidates for the extraction target item.

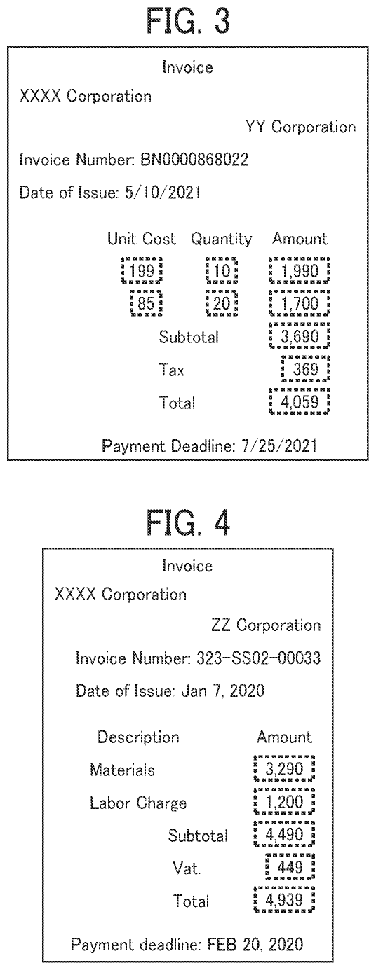

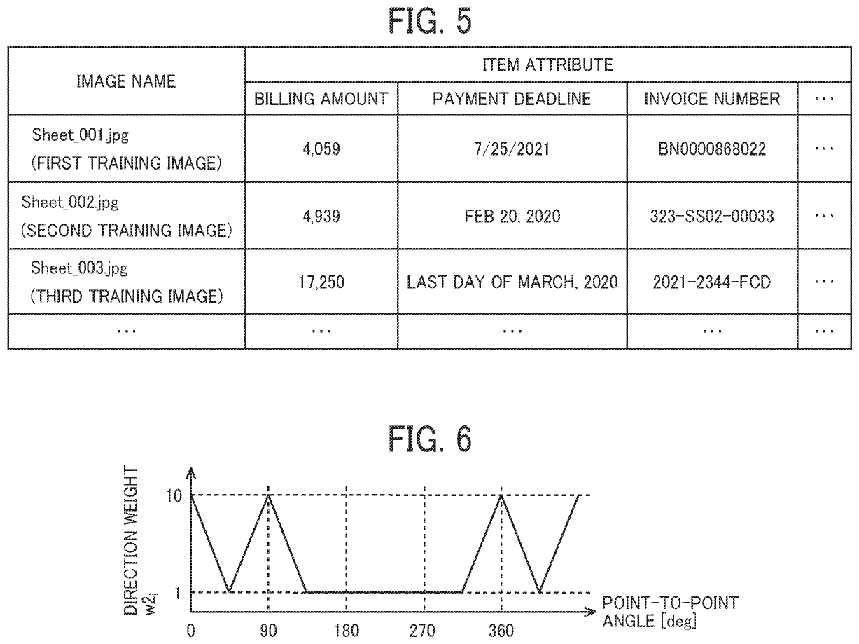

FIGS. 3 and 4 are diagrams illustrating an extraction example of the item value candidates according to the present embodiment. FIG. 3 illustrates a first training image which is a training image for an invoice. FIG. 4 illustrates a second training image which is a training image for an invoice. FIGS. 3 and 4 illustrate a case where the extraction target item attribute is “billing amount” and the format definition for “billing amount” is as illustrated in a specific example of the format definition (FIG. 5). In this case, as indicated by broken lines in FIG. 3, “199”, “10”, “1,990”, “85”, “20”, “1,700”, “3,690”, “369”, and “4,059” are extracted as character strings that match the format definition of the item attribute “billing amount” (as the item value candidates for “billing amount”). Likewise, as indicated by broken lines in FIG. 4, “3,290”, “1,200”, “4,490”, “449”, and “4,939” are extracted as character strings that match the format definition of the item attribute “billing amount” (as the item value candidates for “billing amount”).

The ground truth definition acquisition unit 55 acquires a ground truth definition in which one or more extraction target items are associated with item values of the extraction target items in each training image. In the present embodiment, the ground truth definition acquisition unit 55 acquires the ground truth definition in response to the ground truth definition generated (defined) by the user being input to the training apparatus 2. For example, the user determines the extraction target item (item attribute), and extracts the item value of the extraction target item written in each training image with reference to the training image. The user then stores the extraction target item in association with the item value of the extraction target item in each training image to generate the ground truth definition (ground truth definition table), and inputs the ground truth definition to the training apparatus 2.

FIG. 5 is a diagram illustrating an example of the ground truth definition table according to the present embodiment. FIG. 5 illustrates “billing amount”, “payment deadline”, and “invoice number” as the extraction target item attributes. However, the item attributes are not limited to these, and may be set in any manner. As illustrated in FIG. 5, the ground truth definition (ground truth definition table) stores item values (ground truth definition values) corresponding to respective item attributes in each of a plurality of training images (such as “Sheet_001.jpg”, “Sheet_002.jpg”, and “Sheet_003.jpg”).

For example, “Sheet_001.jpg” is the first training image (see FIG. 3). “Sheet_002.jpg” is the second training image (see FIG. 4). The ground truth definition table illustrated in FIG. 5 stores item values of the item attributes “billing amount”, “payment deadline”, and “invoice number” (item values of the item names corresponding to the respective item attributes) written in each of the first and second training images of FIGS. 3 and 4, respectively. For example, the user stores, in the ground truth definition table, the item value “4,059” of the item name “total”, included in the first training image illustrated in FIG. 3, as the ground truth definition value of the item attribute “billing amount”, the item value “7/25/2021” of the item name “payment deadline”, included in the first training image illustrated in FIG. 3, as the ground truth definition value of the item attribute “payment deadline”, and the item value “BN0000868022” of the item name “invoice number”, included in the first training image illustrated in FIG. 3, as the ground truth definition value of the item attribute “invoice number”. As described above, in the present embodiment, the user inputs the item values of the respective extraction target items written in the training image, so that the ground truth definition (ground truth definition table) is generated.

Note that the data structure for storing the item values (ground truth definition values) is not limited to a table format such as a comma-separated values (CSV) format, and may be any format. The method of acquiring the ground truth definition is not limited to the example described above, and any method such as a method of acquiring the ground truth definition via another apparatus or a method of acquiring the ground truth definition by reading the ground truth definition from the storage device 24 or an external recording medium may be used.

The item keyword determination unit 56 determines a plurality of item keywords that serve as keywords for extracting the item value of the extraction target item. As described later, after extracting the item value candidates for the extraction target item, the information processing apparatus 1 determines an appropriateness of each of the item value candidates based on positional relationships between the item value candidate and the plurality of item keywords, and determines the most appropriate item value candidate as the item value of the extraction target item. Thus, the item keywords are desirably useful for extracting the item value of the extraction target item.

On the other hand, the item name written in the invoice or the like may vary (change) depending on the issuer company. Thus, to deal with various originals issued from various companies, as many keywords as possible may be desirably selected as the item keywords. However, selection of a keyword not related to an item to be extracted or an irregular keyword as the item keyword arises a concern about issues such as an adverse influence on extraction of the item value, an increased scale of the trained model, and a decreased processing speed. Accordingly, in the present embodiment, keywords expected to be useful for extracting the item value are determined (selected) as the item keywords from among word strings written in a form. A method of determining item keywords will be described below. Note that the item keyword determination unit 56 determines a plurality of item keywords for each extraction target item.

The item keyword determination unit 56 determines the position, in a training image, of the item value (ground truth definition value) of the extraction target item attribute stored in the ground truth definition. The item keyword determination unit 56 determines, from the character recognition result of the training image, word strings located near the ground truth definition value whose position is identified, as item keyword candidates of the item attribute. Note that in the present embodiment, the word string is a string of one or more words (word sequence). The word strings located near the ground truth definition value are word strings located within a predetermined range from the ground truth definition value, and are not limited to word strings adjacent to the ground truth definition value and may be word strings included in the entire area of the training image. The item keyword determination unit 56 performs this extraction process of item keyword candidates on each training image.

For example, in the case of the first training image illustrated in FIG. 3, the position of the ground truth definition value “4,059” of the item attribute “billing amount”, which is stored in the ground truth definition, is identified, and word strings (for example, “unit cost”, “amount”, “subtotal”, “total”, and the like) located near the position of the ground truth definition value are extracted as item keyword candidates. For example, in the case of the second training image illustrated in FIG. 4, the position of the ground truth definition value “4,939” of the item attribute “billing amount”, which is stored in the ground truth definition, is identified, and word strings (for example, “description”, “amount”, “subtotal”, “total”, and the like) located near the position of the ground truth definition value are extracted as item keyword candidates.

In the present embodiment, the item keyword determination unit 56 generates, for each extraction target item, an item keyword candidate list including the item keyword candidates extracted in each training image. For example, a list of (single) words located near the ground truth definition value and a list of word strings of a plurality of words (word strings of combinations of a word and words preceding and following the word) located near the ground truth definition value are generated. Then, the item keyword candidate list storing the word strings included in these lists is generated. Note that the method of generating the item keyword candidate list is not limited to the example described above, and the item keyword candidate list may be generated with any method.

As described above, not only words but also word strings including a plurality of words are set as item keyword candidates (item keywords). For example, in the case where an item name is included in another item name such as “total” and “subtotal” and “date”, “due date”, and “invoice date”, the item names are identified with being distinguished from each other and are each extractable as the item keyword candidates (item keywords). This can avoid an adverse influence of confusion of an intended item keyword with another keyword on extraction of an item value.

The item keyword determination unit 56 determines (selects) an item keyword of the extraction target item (item keyword for extracting the item value of the extraction target item) from the item keyword candidates of the extraction target item, which are extracted from each training image. That is, the item keyword of the extraction target item is determined from the item keyword candidates (item keyword candidate list) of the extraction target item each of which is extracted from at least one training image.

The item keyword determination unit 56 determines the item keyword from the item keyword candidates, based on an attribute of the item keyword candidates. The attribute of the item keyword candidates is, for example, at least one attribute from among (1) an appearance frequency of a word string which is the item keyword candidate in the training image, (2) a distance between the item keyword candidate (area) and the ground truth definition value (area) in the training image, and (3) a direction from one of the ground truth definition value (area) and the item keyword candidate (area) toward the other in the training image (for example, the direction of the ground truth definition value viewed from the item keyword candidate). For example, the item keyword may be determined based on at least one of these three attributes. In another embodiment, the item keyword may be determined based on two or all of the three attributes. The item keyword is determined based on these attributes, so that a keyword highly likely to be related to (to have a strong relation with) the item value is successfully selected as the item keyword. A method of determining the item keyword based on each attribute will be described below.

### Attribute (1): Appearance Frequency of Item Keyword Candidate

It is expected that the keyword written in many originals (training images) in common is highly generic and is useful (effective) for extracting the item value. Therefore, the item keyword determination unit 56 increases a probability that a character string written in many originals in common, that is, an item keyword candidate that appears in many training images is selected as the item keyword.

Attribute (2): Distance between Item Keyword Candidate and Ground Truth Definition Value

In many cases, the item name and the item value are written as a set. Thus, it is expected that the item name and the item value are written close to each other. Accordingly, it is expected that a keyword written close to an item value is highly likely to be an item name representing an item of the item value or an item name related to the item value and is also useful for extracting the item value. Therefore, the item keyword determination unit 56 increases a probability that an item keyword candidate having a smaller distance to the ground truth definition value in a training image is selected as the item keyword.

Attribute (3): Direction from One of Ground Truth Definition Value and Item Keyword Candidate to Other

In many cases, the item name is written in a horizontal left direction or vertical above direction of the item value with being aligned with the item value. Thus, it is expected that a keyword written in the horizontal direction or vertical direction of the item value with being aligned with the item value is highly likely to be an item name representing an item of the item value or an item name related to the item value and is also useful for extracting the item value. Therefore, the item keyword determination unit 56 increases a probability that an item keyword candidate located in the horizontal left direction or vertical above direction of the ground truth definition value in a training image is selected as the item keyword.

For each item keyword candidate, the item keyword determination unit 56 may calculate, based on the attribute of the item keyword candidate, an effectiveness score indicating the effectiveness of the item keyword candidate as the keyword for extracting the item value, and determine the item keywords based on the effectiveness scores. For example, the item keyword determination unit 56 selects a predetermined number (for example, 100) item keyword candidates in descending order of the effectiveness score, and determines the selected item keyword candidates as the item keywords. Alternatively, the item keyword determination unit 56 may set a predetermined threshold value for the effectiveness score, and determine the item keyword candidates having the effectiveness score exceeding the predetermined threshold value as the item keywords.

The effectiveness score is calculated based on the attribute of the item keyword candidate. For example, in the case of the attribute (1), the effectiveness score is calculated such that the effectiveness score becomes higher for the item keyword candidate that appears in more training images. In the case of the attribute (2), the effectiveness score is calculated such that the effectiveness score becomes higher for the item keyword candidate having a smaller distance to the ground truth definition value. In the case of the attribute (3), the effectiveness score is calculated such that the effectiveness score becomes higher for the item keyword candidate located in the horizontal left direction or vertical above direction of the ground truth definition value.

Note that the effectiveness score is calculated at least one attribute among the three attributes described above, and the calculation method may be any method. A method using weighting (a weight based on the distance and a weight based on the direction (angle)) will be described below as an example of calculating the effectiveness score based on the three attributes described above. In this method, the effectiveness score (total effectiveness score) S of the item keyword candidate is calculated using Equation 1 below.

$$S = {\sum }_{i = 1}^{N} ( {S}_{i} ) = {\sum }_{i = 1}^{N} ( {x}_{i} \times w {1}_{i} \times w {2}_{i} )$$

In Equation 1 above, Sᵢ denotes a single effectiveness score in a training image i, xᵢ denotes an appearance count of the item keyword candidate in the training image i, w1ᵢ denotes a weight for the attribute (2) in the training image i, w2ᵢ denotes a weight for the attribute (3) in the training image i, and N denotes the number of training images.

Sᵢ denotes the single effectiveness score in the training image i. The single effectiveness score is an effectiveness score of the item keyword candidate calculated in each training image. The effectiveness score (total effectiveness score) S is calculated as the sum of the single effectiveness scores for all the training images.

xᵢ denotes the appearance count (value indicating the appearance frequency) of the item keyword candidate in the training image i. For example, the number of times (positions where) the item keyword candidate is detected in the character recognition result of the training image i is input to xᵢ. In many cases, it is expected that the word string that is the item keyword candidate appears just once in one training image. In this case, xᵢ=1 is obtained. If the character recognition result of the training image does not include the target item keyword candidate, xᵢ=0 is obtained. Note that if the same item keyword candidate is detected multiple times in one training image, the count is set to the number of detections, and a distance weight and a direction weight for one of the multiple detections may be used as the distance weight and the direction weight, respectively. Alternatively, the single effectiveness score (the count (=1)×the distance weight×the direction weight) is calculated for each detection, and the resultant single effectiveness scores are summed. In this manner, the single effectiveness score for the training image may be calculated.

Note that in the present embodiment, the appearance count of the item keyword candidate is the number of times (number of positions where) the item keyword candidate is detected in the training image. However, the appearance count of the item keyword candidate is not limited to this example, and may be a numerical value indicating whether the item keyword candidate is detected in the training image. That is, even if the item keyword candidate is detected multiple times in one training image, xᵢ=1 may be obtained. As described above, when the appearance count described above is used, the total effectiveness score becomes a summed score of the single effectiveness scores of the training images in which the item keyword candidate appears. Thus, the effectiveness score can be calculated such that the effectiveness score becomes higher for the item keyword candidate that appears more training images.

w1ᵢ denotes the weight (hereinafter, referred to as a “distance weight”) for the attribute (2) in the training image i. If the distance between the ground truth definition value and a character string serving as the item keyword candidate detected in the training image i is small, that is, if the ground truth definition value and the character string are close to each other, the value (weight) is calculated to be large. For example, if the detected item keyword candidate and the ground truth definition value are located at the respective ends of the original (training image) and are separate from each other, that is, if the distance between the detected item keyword candidate and the ground truth definition value is equal to a length of a diagonal of the original (longest distance), the distance weight is set to a minimum value (for example, 1). On the other hand, if the detected item keyword candidate and the ground truth definition value are adjacent to each other, that is, if the distance between the detected item keyword candidate and the ground truth definition value is the shortest distance, the distance weight is set to a maximum value (for example, 10). If the distance between the detected item keyword candidate and the ground truth definition value is between the shortest distance and the longest distance, the distance weight is calculated to linearly decrease. For example, the distance weight is calculated to linearly decrease as the distance between the detected item keyword candidate and the ground truth definition value increases.

w2ᵢ denotes the weight (hereinafter, referred to as a “direction weight”) for the attribute (3) in the training image i. If a character string serving as the item keyword candidate detected in the training image i is in the horizontal left direction or vertical above direction of the ground truth definition value, the value (weight) is calculated to be large. Specifically, based on a degree at which the item keyword candidate is located in the horizontal left direction or vertical above direction of the ground truth definition value, the direction weight is calculated. For example, the direction weight w2ᵢ in the training image i is calculated using Equation 2 below.

$$w {2}_{i} = max ( w {2}_{hi} , w {2}_{ν i} )$$

In Equation 2 above, w2ₕᵢ denotes a first weight for the attribute (3) in the training image i, and w2ᵥᵢ denotes a second weight for the attribute (3) in the training image i.

The first weight w2hi (hereinafter, referred to as a “first direction weight”) for the attribute (3) in the training image i is a weight based on the degree at which the item keyword candidate is located in the horizontal left direction of the ground truth definition value in the training image i. The first direction weight is calculated such that the value increases as the character string of the item keyword candidate detected in the training image is closer to the horizontal left direction of the ground truth definition value. For example, if the item keyword candidate is in the horizontal left direction of the ground truth definition value, that is, an angle between the horizontal right direction (x axis) and a vector from the item keyword candidate toward the ground truth definition value (hereinafter, referred to as an “point-to-point angle”) is 0 degrees, the first direction weight is set to a maximum value (for example, 10). The value of the first direction weight decreases as the vector inclines. If the point-to-point angle is equal to 45 degrees and −45 degrees, the first direction weight is set to a minimum value (for example, 1). If the point-to-point angle is outside the range of 0 degrees±45 degrees, the first direction weight is set to the minimum value (for example, 1). Note that the clockwise direction is the positive direction of the point-to-point angle (the direction in which the angle increases).

The second weight w2ᵥᵢ (hereinafter, referred to as a “second direction weight”) for the attribute (3) in the training image i is a weight based on the degree at which the item keyword candidate is located in the vertical above direction of the ground truth definition value in the training image i. The second direction weight is calculated such that the value increases as the character string of the item keyword candidate detected in the training image is closer to the vertical above direction of the ground truth definition value. For example, if the item keyword candidate is in the vertical above direction of the ground truth definition value, that is, the point-to-point angle is 90 degrees, the second direction weight is set to a maximum value (for example, 10). The value of the second direction weight decreases as the vector inclines. If the point-to-point angle is equal to 45 degrees and 135 degrees, the second direction weight is set to a minimum value (for example, 1). If the point-to-point angle is outside the range of 90 degrees+45 degrees, the second direction weight is set to the minimum value (for example, 1).

Note that in the present embodiment, the point-to-point angle is calculated as the direction weight for the ground truth definition value and the item keyword candidate. However, the direction weight is not limited to this. For example, the ground truth definition value is set as the origin, and a guadrant in which the item keyword candidate is located among the first to fourth quadrants may be determined to calculate the direction weight. For example, the first direction weight may be calculated to be large if the item keyword candidate is determined to be in the second quadrant or the third quadrant. For example, the second direction weight may be calculated to be large if the item keyword candidate is determined to be in the first quadrant or the second quadrant.

FIG. 6 is a diagram illustrating a calculation example of the direction weight according to the present embodiment. In FIG. 6, the horizontal axis denotes the point-to-point angle, and the vertical axis denotes the direction weight. In FIG. 6, the direction weight (first direction weight, second direction weight) has the minimum value of 1 and the maximum value of 10.

When the point-to-point angle is from 0 degrees to 45 degrees, since the first direction weight is greater than the second direction weight as described above, w2ᵢ=w2ₕᵢ holds. As a result, in this angle range, the direction weight linearly decreases from the maximum value of 10 to the minimum value of 1 as illustrated in FIG. 6. When the point-to-point angle is from 45 degrees to 90 degrees, since the second direction weight is greater than the first direction weight as described above, w2ᵢ=w2ᵥᵢ holds. As a result, in this angle range, the direction weight linearly increases from the minimum value of 1 to the maximum value of 10 as illustrated in FIG. 6. When the point-to-point angle is from 90 degrees to 135 degrees, since the second direction weight is greater than the first direction weight as described above, w2ᵢ=w2ᵥᵢ holds. As a result, in this angle range, the direction weight linearly decreases from the maximum value of 10 to the minimum value of 1 as illustrated in FIG. 6. When the point-to-point angle is from 135 degrees to 315 degrees, since the first direction weight and the second direction weight are equal to the minimum value of 1 as described above, w2ᵢ=w2ₕᵢ=w2ᵥᵢ=the minimum value of 1 holds. When the point-to-point angle is from 315 degrees to 360 degrees, since the first direction weight is greater than the second direction weight as described above, w2ᵢ=w2ₕᵢ holds. As a result, in this angle range, the direction weight linearly increases from the minimum value of 1 to the maximum value of 10 as illustrated in FIG. 6.

Note that the minimum value and the maximum value of the distance weight and the direction weight are adjustable (settable) to any numerical value. The range of the point-to-point angle in which the direction weight changes from the maximum value to the minimum value is not limited to the range of ±45 degrees, and is adjustable to any angle (range). In the present embodiment, the point-to-point angle for the ground truth definition value and the item keyword candidate is the angle between the horizontal right direction and the vector from the item keyword candidate toward the ground truth definition value. However, the point-to-point angle is not limited to the angle relative to the horizontal right direction and may be any angle indicating the direction of the vector. The point-to-point angle may be an angle between the horizontal right direction and a vector from the ground truth definition value toward the item keyword candidate.

In calculation of the distance between the ground truth definition value and the item keyword candidate and the point-to-point angle, any point in an area of the ground truth definition value and any point in an area of the item keyword candidate in the training image may be used. For example, an upper left vertex of a circumscribed rectangle of the ground truth definition value and an upper left vertex of a circumscribed rectangle of the item keyword candidate in the training image may be used. Specifically, based on a vector from the upper left vertex of the circumscribed rectangle of the item keyword candidate in the training image toward the upper left vertex of the circumscribed rectangle of the ground truth definition value in the training image, the distance between the upper left vertices and the point-to-point angle may be calculated (extracted). A calculation example of the distance weight and the direction weight in the first training image and the second training image will be described below.

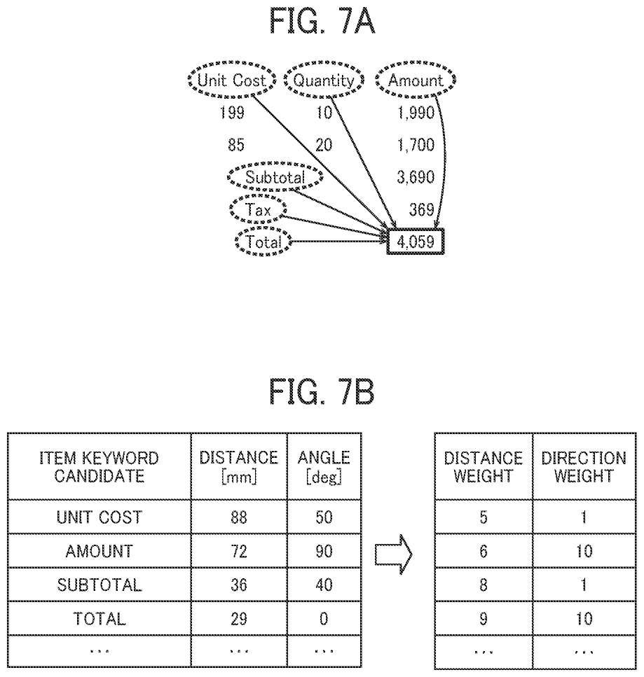

FIGS. 7A and 7B are diagrams illustrating a calculation example of the distance weight and the direction weight in the first training image according to the present embodiment. FIG. 7B presents examples of numerical values of the distance weights and the direction weights for the respective item keyword candidates (such as “unit cost”, “amount”, “subtotal”, and “total”) of the item attribute “billing amount” in the first training image. As illustrated in FIG. 7B, for example, distances between the ground truth definition value “4,059” of the item attribute “billing amount” and the item keyword candidates “unit cost”, “amount”, “subtotal”, and “total” in the first training image are calculated to be “88 mm”, “72 mm”, “36 mm”, and “29 mm”, respectively. As illustrated in FIG. 7B, for example, angles (angles between two points) from the item keyword candidates “unit cost”, “amount”, “subtotal”, and “total” toward the ground truth definition value “4,059” in the first training image are calculated to be “50 degrees”, “90 degrees”, “40 degrees”, and “0 degrees”, respectively.

Then, based on the above-described calculation method of the distance weight and the direction weight, the calculated distances and the calculated angles between two points are converted into the distance weights and the direction weights, respectively. As illustrated in FIG. 7B, for example, the distance weights for the respective item keyword candidates “unit cost”, “amount”, “subtotal”, and “total” are calculated to be “5”, “6”, “8”, and “9”, respectively. The direction weights for the respective item keyword candidates “unit cost”, “amount”, “subtotal”, and “total” are calculated to be “1”, “10”, “1”, and “10”, respectively.

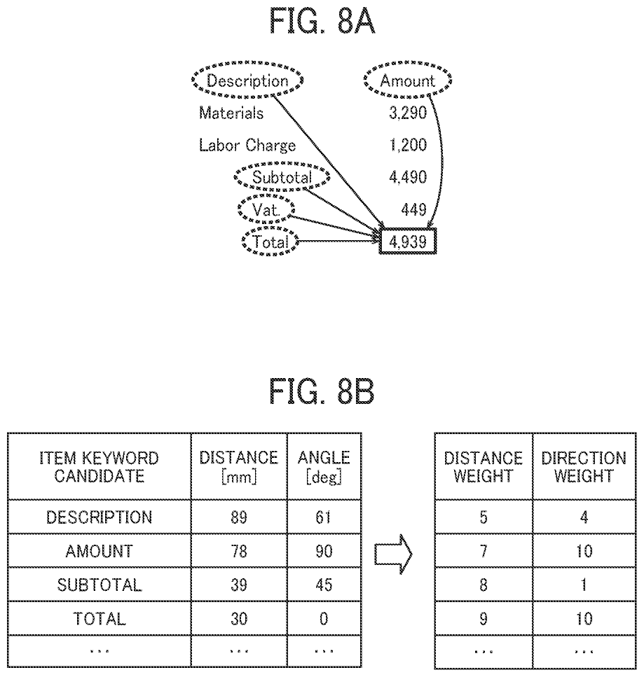

FIGS. 8A and 8B are diagrams illustrating a calculation example of the distance weights and the direction weights in the second training image according to the present embodiment. FIG. 8B presents examples of numerical values of the distance weights and the direction weights for the respective item keyword candidates (such as “unit cost”, “amount”, “subtotal”, and “total”) of the item attribute “billing amount” in the second training image. As illustrated in FIG. 8B, for example, distances between the ground truth definition value “4,939” of the item attribute “billing amount” and the item keyword candidates “description”, “amount”, “subtotal”, and “total” in the second training image are calculated to be “89 mm”, “78 mm”, “39 mm”, and “30 mm”, respectively. As illustrated in FIG. 8B, for example, angles (angles between two points) from the item keyword candidates “description”, “amount”, “subtotal”, and “total” toward the ground truth definition value “4,939” in the second training image are calculated to be “61 degrees”, “90 degrees”, “45 degrees”, and “0 degrees”, respectively.

Then, based on the above-described calculation method of the distance weight and the direction weight, the calculated distances and the calculated angles between two points are converted into the distance weights and the direction weights, respectively. As illustrated in FIG. 8B, for example, the distance weights for the respective item keyword candidates “description”, “amount”, “subtotal”, and “total” are calculated to be “5”, “7”, “8”, and “9”, respectively. The direction weights for the respective item keyword candidates “description”, “amount”, “subtotal”, and “total” are calculated to be “4”, “10”, “1”, and “10”, respectively.

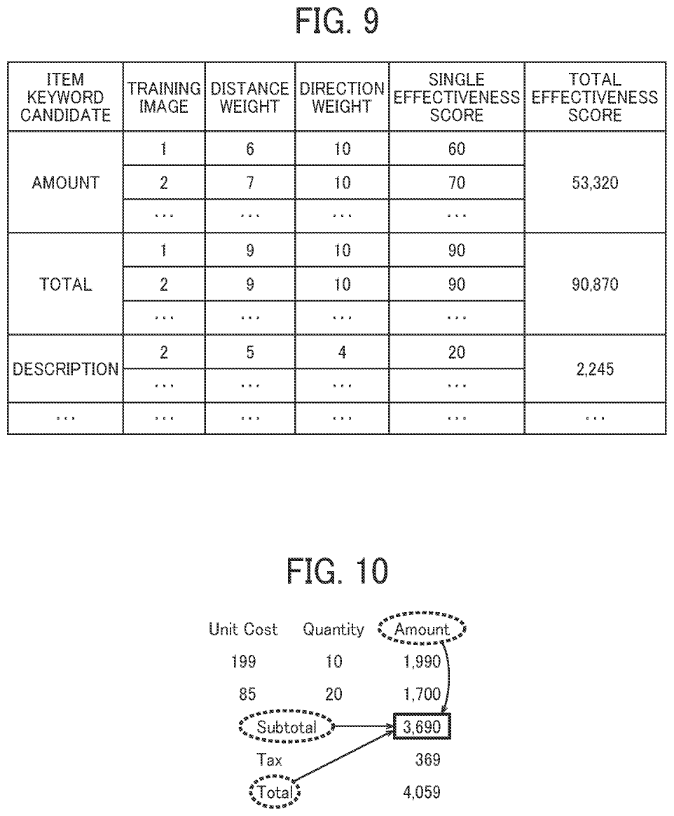

FIG. 9 is a diagram illustrating a calculation example of the effectiveness score according to the present embodiment. FIG. 9 illustrates examples of the numerical values of the effectiveness score, of each item keyword candidate of the item attribute “billing amount”, calculated based on the distance weights and the direction weights calculated in the first training image and the second training image in FIGS. 7A and 7B and FIGS. 8A and 8B. As illustrated in FIG. 9, for each item keyword candidate, the distance weight and the direction weight are calculated for each training image in which the item keyword candidate is detected. Based on these calculated weights, the effectiveness score (single effectiveness score, total effectiveness score) is calculated.

For example, as illustrated in FIGS. 7A and 7B and FIGS. 8A and 8B, the item keyword candidate “amount” is detected in the first training image and the second training image, and the distance weight and the direction weight are calculated in each of the first training image and the second training image. For example, the distance weight and the direction weight of the item keyword candidate “amount” detected in the first training image are “6” and “10”, respectively. Thus, based on Equation 1, the single effectiveness score is calculated as “single effectiveness score=1×6×10=60”. Likewise, the distance weight and the direction weight of the item keyword candidate “amount” detected in the second training image are “7” and “10”, respectively. Thus, based on Equation 1, the single effectiveness score is calculated as “single effectiveness score=1×7×10=70”.

Then, as illustrated in FIG. 9, the single effectiveness scores of the item keyword candidate “amount” for the first training image to an N-th training image are summed, and the total effectiveness score of the item keyword candidate “amount” for the item attribute “billing amount” is calculated to be “53,320”. Likewise, for example, the total effectiveness scores of the item keyword candidates “total” and “description” for the item attribute “billing amount” are calculated to be “90,870” and “2,245”, respectively. Note that the item keyword determination unit 56 may generate, as a calculation result of the single effectiveness scores and the total effectiveness scores, a table illustrated in FIG. 9 (table storing the training image, the distance weight, the direction weight, and the effectiveness scores (the single effectiveness score and the total effectiveness score).

Based on the effectiveness score (total effectiveness score) calculated according to the calculation method of the effectiveness score presented as an example, the item keyword determination unit 56 determines a plurality of item keywords from among the item keyword candidates. In the present embodiment, the item keyword determination unit 56 generates, for each extraction target item, an item keyword list including the determined item keywords. The generated item keyword list is stored in the storage unit 59. Note that the data structure for storing the item keywords is not limited to the list format, and may be any other format.

In the related art, in an item value extraction method for a semi-fixed-format form, an extraction rule of an item value is created based on a correspondence between an item name and an item value. However, the item name (keyword) corresponding to the item value to be extracted is determined through observation of the semi-fixed-format form by a skilled engineer or the like. In contrast, in the present embodiment, the item keywords for extracting (identifying) the item value is automatically determined by the item keyword determination unit 56. This thus omits the user's work for manually determining the item keyword and reduces the work load of the user.

The feature generation unit 57 generates a feature quantity of each item value candidate for the extraction target item in a training image. The feature generation unit 57 generates a feature quantity of an item value candidate, based on positional relationships between the item value candidate and a plurality of item keywords for the extraction target item in a training image. The feature generation unit 57 generates a feature quantity of the item value candidate in each training image. In a training process (described below), a feature quantity of each item value candidate is used as a feature quantity for extracting an item value (input of a trained model).

The feature generation unit 57 generates a feature quantity of an item value candidate, based on information (hereinafter, referred to as “positional relationship information”) indicating positional relationships between the item value candidate and a plurality of item keywords of the extraction target item in a training image. The positional relationship information to be used is information indicating a distance between the item value candidate and each item keyword and information indicating a direction from one of the item value candidate and each item keyword toward the other. In the present embodiment, as the positional relationship information, a distance (mm) between the item value candidate and each item keyword in a training image and an angle (point-to-point angle) (deg) of a vector from the item keyword toward the item value candidate in the training image are used.

FIG. 10 is a diagram illustrating an extraction example of positional relationship information in the first training image according to the present embodiment. As illustrated in FIG. 10, in the case of the item value candidate “3,690” for the item attribute “billing amount” in the first training image, a length and a direction of a vector from each of item keywords (such as “total”, “subtotal”, and “amount”) of the item attribute “billing amount” toward the item value candidate “3,690”, that is, a distance and a direction (point-to-point angle) between each item keyword and the item value candidate, are extracted as the positional relationship information.

Note that similarly to the point-to-point angle between the ground truth definition value and each item keyword candidate described above, the point-to-point angle between the item value candidate and each item keyword is not limited to an angle relative to the horizontal right direction and may be an angle of a vector from the item value candidate toward each item keyword. In calculation of the distance and the point-to-point angle between the item value candidate and each item keyword, any point in an area of the item value candidate and any point in an area of the item keyword in the training image may be used. The feature generation unit 57 generates, for each extraction target item, a positional relationship information list that stores the positional relationship information.

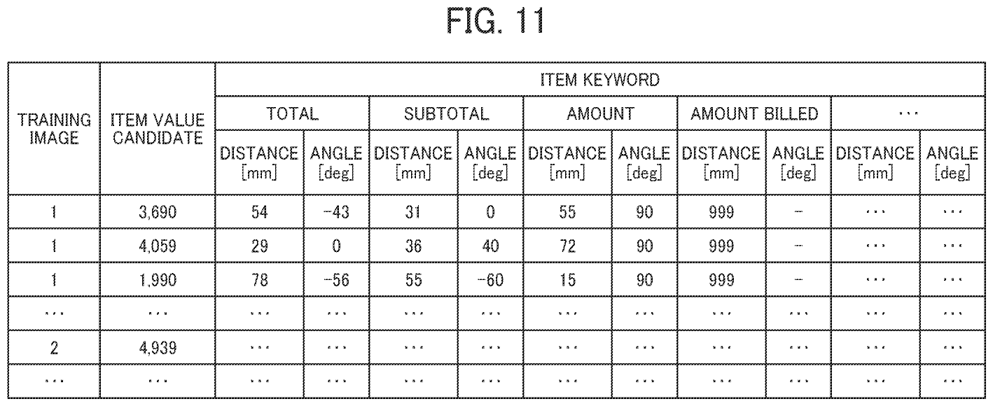

FIG. 11 is a diagram illustrating an example of the positional relationship information list in the training process according to the present embodiment. FIG. 11 illustrates the positional relationship information list for the item attribute “billing amount”. As illustrated in FIG. 11, the positional relationship information list stores each item value candidate for the item attribute “billing amount” extracted from each training image, and positional relationship information (distances and point-to-point angles) between the item value candidate and a plurality of item keywords of the item attribute “billing amount”. As illustrated in FIG. 11, for example, the positional relationship information list stores information indicating positional relationships between each of item value candidates (such as “3,690”, “4,059”, and “1,990” (see FIG. 3)) for the item attribute “billing amount” and a plurality of item keywords (such as “total”, “subtotal”, “amount”, “amount billed”) of the item attribute “billing amount” in the first training image.

Note that units of the positional relationship information (distance and point-to-point angle) are not limited to units (“mm” and “deg”) illustrated in FIG. 11. The item keyword “amount billed” in the positional relationship information list of FIG. 11 is a keyword not included in the first training image. Thus, values (“999” and “- (hyphen)”) indicating “not available” are respectively set for the distance and the point-to-point angle to the item keyword “amount billed”. However, the values indicating “not available” are not limited to these values, and any numerical value, character, symbol, or the like may be used. In the present embodiment, the list format (table format) is presented as an example of the data structure for storing the positional relationship information. However, the data structure may be any other format.

Based on the extracted positional relationship information (distance and point-to-point-to-point angle between the item value candidate and each item keyword), the feature generation unit 57 generates feature quantities (a distance feature quantity and a direction feature quantity) of the item value candidate. In the present embodiment, the feature generation unit 57 converts the distance and the point-to-point angle into the distance feature quantity and the direction feature quantity, respectively, in accordance with a probability of the item value candidate and each item keyword being related (correlated) with each other (of the item keyword being an effective keyword related to the item value candidate). This enables the feature quantities according to the strength of the relationship between the item value candidate and the item keyword to be learned, and thus enables extraction of the item value with a higher accuracy.

### Generation of Distance Feature Quantity

The distance feature quantity is a feature quantity based on information indicating a distance between an item value candidate and an item keyword. As described above, the item name and the item value are written as a set in many cases. Thus, it is expected that the item name and the item value are written close to each other. Thus, it is expected that when the distance between the item value candidate and the item keyword is smaller, the item value candidate and the item keyword are more likely to relate to each other. Accordingly, the feature generation unit 57 generates (calculates) the distance feature quantity such that the value of the feature quantity increases or decreases in accordance with the distance between the item value candidate and the item keyword. In the present embodiment, the present embodiment, the distance feature quantity is calculated such that the value of the feature quantity increases as the distance between the item value candidate and the item keyword decreases. For example, the distance feature quantity is set to a maximum value of 100 points when the item value candidate and the item keyword are in close proximity to each other. The value of the distance feature quantity decreases as the item value candidate and the item keyword become away from each other. The distance feature quantity is set to a minimum value of 0 points when the item value candidate and the item keyword are at respective ends of the original.

Conversion into Direction Feature Quantity

The direction feature quantity is a feature quantity based on information indicating a direction from one of an item value candidate and an item keyword toward the other. As described above, the item name is written on the left side of or above the item value with being aligned with the item value in many cases. Thus, it is expected that when the item keyword is in the horizontal left direction and vertical above direction of the item value candidate, the item value candidate and the item keyword are more likely to relate to each other. Accordingly, the feature generation unit 57 generates (calculates) the direction feature quantity such that the value of the direction feature quantity increases or decreases in accordance with a degree at which the item keyword is located in the horizontal left direction or vertical above direction of the item value candidate. In the present embodiment, the direction feature quantity is divided into two feature quantities that are a horizontal direction feature quantity and a vertical direction feature quantity. The horizontal direction feature quantity increases or decreases in accordance with the degree at which the item keyword is located in the horizontal left direction of the item value candidate. The vertical direction feature quantity increases or decreases in accordance with the degree at which the item keyword is located in the vertical above direction of the item value candidate.

In the present embodiment, the horizontal direction feature quantity is calculated such that the value of the horizontal direction feature quantity increases as the direction of the item keyword relative to the item value candidate is closer to the horizontal left direction of the item value candidate. Likewise, the vertical direction feature quantity is calculated such that the value of the vertical direction feature quantity increases as the direction of the item keyword relative to the item value candidate is closer to the vertical above direction of the item value candidate. For example, the horizontal direction feature quantity is set to the maximum value of 100 points when the point-to-point angle is 0 degrees (when the item keyword is in the horizontal left direction of the item value candidate). The value of the horizontal direction feature quantity decreases as the vector between the item value candidate and the item keyword inclines. The horizontal direction feature quantity is set to the minimum value of 0 points when the point-to-point angle is in a range of 0 degrees+90 degrees. Note that the horizontal direction feature quantity is set to the minimum value of 0 points also when the point-to-point angle is output the range of 0 degrees+90 degrees. Likewise, the vertical direction feature quantity is set to the maximum value of 100 points when the point-to-point angle is 90 degrees (when the item keyword is in the vertical above direction of the item value candidate). The value of the vertical direction feature quantity decreases as the vector between the item value candidate and the item keyword inclines. The vertical direction feature quantity is set to the minimum value of 0 points when the point-to-point angle is in a range of 90 degrees+90 degrees. Note that the vertical direction feature quantity is set to the minimum value of 0 points also when the point-to-point angle is output the range of 90 degrees+90 degrees. Note that the minimum value and the maximum value of the feature quantities are adjustable (settable) to any numerical value.

The feature generation unit 57 generates a feature list that stores the feature quantities (the distance feature quantity and the direction feature quantity) of each item value candidate based on the positional relationship information.

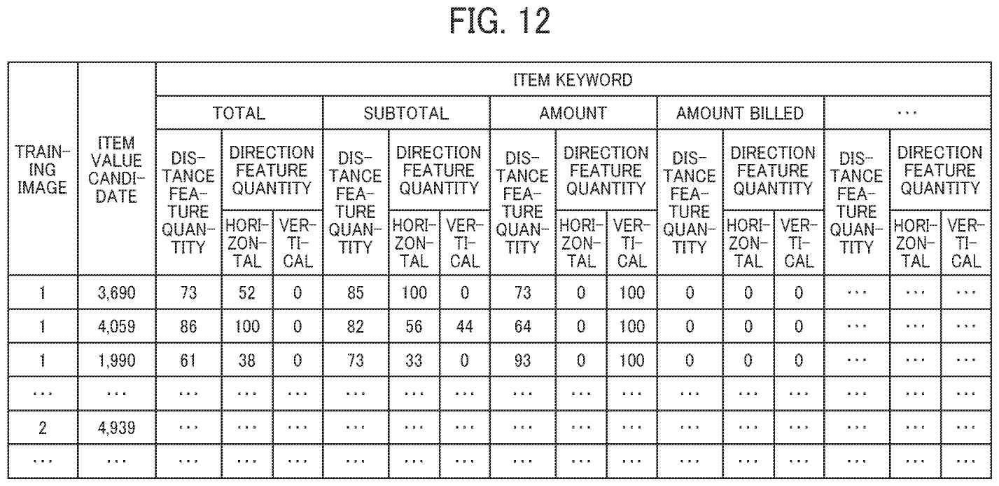

FIG. 12 is a diagram illustrating an example of the feature list in the training process according to the present embodiment. As illustrated in FIG. 12, the distance feature quantity is calculated such that the value increases as the distance between the item value candidate and the item keyword decreases. The horizontal direction feature quantity is calculated such that the value increases as the direction of the item keyword relative to the item value candidate is closer to the horizontal left direction of the item value candidate. The vertical direction feature quantity is calculated such that the value increases as the direction of the item keyword relative to the item value candidate is closer to the vertical above direction of the item value candidate.

Note that in the present embodiment, an example is presented in which the feature quantity is calculated to increase (have greater points) when the item value candidate and the item keyword are more likely to relate to each other. However, the calculation is not limited to this example, and the feature quantity may be calculated to decrease when the item value candidate and the item keyword are less likely to relate to each other. The feature quantity of the item value candidate that serves as input of the trained model may be the positional relationship information.

The model generation unit 58 performs machine learning (supervised learning) to generate, for each extraction target item of a predetermined document type, a trained model for extracting an item value of the extraction target item. In the machine learning, training data (dataset (labeled training data) of a feature quantity and a ground truth label) is used. In the training data, a feature quantity of each item value candidate in each training image is associated with information (ground truth label) indicating whether the item value candidate is the item value (ground truth definition value) of the extraction target item.

The information (ground truth label) indicating whether the item value candidate is the ground truth definition value is information based on the ground truth definition acquired by the ground truth definition acquisition unit 55. For example, the item value candidate “4,059” of the item attribute “billing amount” in the first training image, which is illustrated in FIG. 12, matches the ground truth definition value of the item attribute “billing amount” in the first training image in the ground truth definition table illustrated in FIG. 5. Thus, the ground truth label of this item value candidate is determined to be “true (a label of 1, for example)”. For example, the item value candidate “3,690” of the item attribute “billing amount” in the first training image, which is illustrated in FIG. 12, does not match the ground truth definition value of the item attribute “billing amount” in the first training image in the ground truth definition table illustrated in FIG. 5. Thus, the ground truth label of this item value candidate is determined to be “false (a label of 0, for example)”. Through machine learning using the training data described above, the feature quantity (positional relationship) of the item value can be learned.

In this manner, an identifier can be generated that determines, in response to receipt of a feature quantity of a character string in an image (a feature quantity based on the positional relationships between the character string and a plurality of item keywords of the extraction target item in the image), whether the character string is the item value of the extraction target item. More specifically, an identifier (trained model) can be generated that outputs, in response to receipt of a feature quantity of a character string, information indicating the appropriateness of the character string being the item value of the extraction target item. Note that the information indicating the appropriateness of the character string being the item value of the extraction target item is information (such as a label) indicating whether the character string is the item value of the extraction target item and/or information (such as a reliability or likelihood) indicating a probability of the character string being the item value of the extraction target item. The generated trained model is stored in the storage unit 59.

Note that a machine learning model of classification type is used for the trained model. However, the trained model may be any model such as a discriminative model or a generative model. The method of machine learning may be any method. Any method among random forest, naive Bayes, decision tree, logistic regression, neural network, and the like may be used. In the present embodiment, training data is used in which, for each item value candidate, a feature quantity based on positional relationships between the item value candidate and a plurality of item keywords is associated with information indicating whether the item value candidate is the item value of the extraction target item is used. However, the training data is not limited to this example. For example, training data may be used in which, for each character string among a character string that is the item value (ground truth definition value) of the extraction target item and other character strings included in each training image, a feature quantity based on positional relationships between the character string and a plurality of item keywords is associated with information indicating whether the character string is the item value of the extraction target item.

The storage unit 59 stores the item keyword list that is generated for each extraction target item by the item keyword determination unit 56, and the trained model that is generated by the model generation unit 58 and extracts the item value of the item attribute. The storage unit 59 may store, for each extraction target item, the item keyword list and the trained model in association with each other.

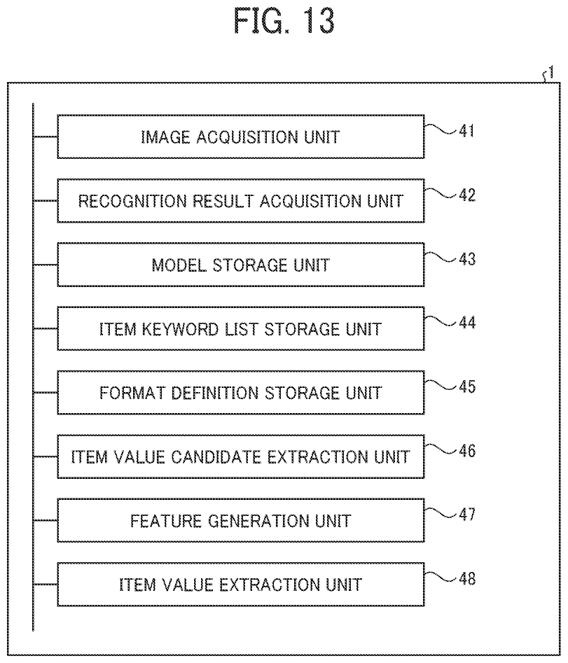

FIG. 13 is a schematic diagram illustrating a functional configuration of an information processing apparatus according to the present embodiment. The CPU 11 of the information processing apparatus 1 reads a program recorded in the storage device 14 to the RAM 13 and executes the program, so that the pieces of hardware of the information processing apparatus 1 are controlled. Consequently, the information processing apparatus 1 functions as an apparatus including an image acquisition unit 41, a recognition result acquisition unit 42, a model storage unit 43, an item keyword list storage unit 44, a format definition storage unit 45, an item value candidate extraction unit 46, a feature generation unit 47, and an item value extraction unit 48. In the present embodiment and other embodiments described below, the functions of the information processing apparatus 1 are executed by the CPU 11 which is a general-purpose processor. Alternatively, a part or all of these functions may be executed by one or multiple dedicated processors. Each of the functions of the information processing apparatus 1 is not limited to a function implemented by an apparatus (single apparatus) having a single housing, and may be implemented remotely and/or in a distributed manner (for example, in cloud).

The image acquisition unit 41 acquires a form image (hereinafter, referred to as an “extraction target image”) that is a target from which an item value is extracted in an item value extraction process. In the present embodiment, for example, in response to a scan instruction from a user, the document reading device 3A reads an original (document) subjected to extraction. The image acquisition unit 41 acquires, as the extraction target image, a scanned image resulting from the reading.

The recognition result acquisition unit 42 acquires a character recognition result (full-text OCR result) of the extraction target image. Note that since a process of the recognition result acquisition unit 42 is substantially the same as the process of the recognition result acquisition unit 52, a detailed description is omitted.

The model storage unit 43 stores a trained model that is generated in the training apparatus 2 and extracts an item value of an extraction target item in a predetermined document type. Note that the model storage unit 43 stores a trained model for each extraction target item. Since details of the trained model have been described in the description of the functional configuration (the model generation unit 58) of the training apparatus 2, the description is omitted.

The item keyword list storage unit 44 stores an item keyword list generated in the training apparatus 2 and to be used for extracting an item value of an extraction target item in a predetermined document type. Note that the item keyword list storage unit 44 stores an item keyword list for each extraction target item. Since details of the item keyword list have been described in the description of the functional configuration (the item keyword determination unit 56) of the training apparatus 2, the description is omitted.

The format definition storage unit 45 stores a format definition of an extraction target item used in an item value candidate extraction process. Since details of the format definition have been described in the description of the functional configuration (the format definition storage unit 53) of the training apparatus 2, the description is omitted. Note that the format definition stored in the format definition storage unit 45 is not limited to the same format definition as the format definition stored in the format definition storage unit 53 and may be any format definition that defines a character string format of the extraction target item and is different from the format definition stored in the format definition storage unit 53.

The item value candidate extraction unit 46 extracts candidate character strings (item value candidates) which are character strings that can be an item value of an extraction target item from the character recognition result of the extraction target image. The item value candidate extraction unit 46 extracts, from the character recognition result acquired by the recognition result acquisition unit 42, character strings that match the format definition of the item attribute stored in the format definition storage unit 45 as the item value candidates of the item attribute. Note that since the item value candidate extraction method performed by the item value candidate extraction unit 46 is substantially the same as the method that has been described in the description of the functional configuration (the item value candidate extraction unit 54) of the training apparatus 2, the description is omitted.

The feature generation unit 47 generates a feature quantity of each item value candidate for the extraction target item in the extraction target image. The feature generation unit 47 generates a feature quantity of an item value candidate, based on positional relationships between each item value candidate for the extraction target item, which is extracted by the item value candidate extraction unit 46, and a plurality of item keywords of the extraction target item, which are stored in the item keyword list storage unit 44. Since the feature quantity generation method performed by the feature generation unit 47 is substantially the same as the method that has been described in the description of the functional configuration (the feature generation unit 57) of the training apparatus 2, the description is omitted.

The feature generation unit 47 generates a positional relationship information list and a feature list for the extraction target image. Since these lists are substantially the same as the positional relationship information list and the feature list (FIGS. 10 and 11) generated by the feature generation unit 57, the description is omitted. The lists (FIGS. 10 and 11) generated by the feature generation unit 57 are for the item value candidates in each training image. Unlike these lists, the feature list generated by the feature generation unit 47 is for item value candidates in the extraction target image.

The item value extraction unit 48 uses the trained model to extract (determine) an item value candidate that is likely to be the item value of the extraction target item from the plurality of item value candidates of the extraction target item in the extraction target image. The item value extraction unit 48 inputs feature quantities (a distance feature quantity and a direction feature quantity) of each item value candidate for the extraction target item to the trained model of the extraction target item, and thus determines whether the item value candidate is appropriate as the item value of the extraction target item. The item value extraction unit 48 outputs a determination result (extracted item value candidate). As described above, in response to feature quantities of a character string being input to the trained model, information (a label and/or a likelihood) indicating the appropriateness of the character string being the item value of the extraction target item is output from the trained model. In the present embodiment, the item value extraction unit 48 inputs the feature quantities of each item value candidate to the trained model, and thus acquires information indicating whether the item value candidate is the item value of the extraction target item (a label, for example, a label of “1” when the item value candidate is the item value of the extraction target item; otherwise, a label of “0”) and information (such as a reliability or likelihood) indicating a probability of the item value candidate being the item value of the extraction target item.

Note that, for example, if a likelihood of the item value candidate being the item value of the extraction target item exceeds a likelihood of the item value candidate not being the item value of the extraction target item or exceeds a predetermined threshold value, it is determined that the item value candidate is the item value of the extraction target item. Accordingly, the item value extraction unit 48 may acquire the likelihood of each item value candidate being the item value of the extraction target item from the trained model, and determine whether the item value candidate is the item value of the extraction target item based on the acquired likelihood.

The item value extraction unit 48 calculates an appropriateness score indicating a probability of an item value candidate being the item value of the extraction target item, based on the information (such as a reliability or likelihood), output from the trained model, indicating the probability of the item value candidate being the item value of the extraction target item. Note that the appropriateness score may be the information (such as a likelihood) indicating the probability output from the trained model, or may be a numerical value (score) calculated based on the information (such as a likelihood) indicating the probability. An item value extraction method using the appropriateness score will be described below.

If a single item value candidate is determined to be appropriate as the item value of the extraction target item, the item value extraction unit 48 determines the item value candidate as the item value of the extraction target item. On the other hand, if a plurality of item value candidates are determined to be appropriate as the item value of the extraction target item, the item value extraction unit 48 determines an item value candidate having the highest appropriateness score among the plurality of item value candidates as an item value candidate that is likely to be the item value of the extraction target item and determines the item value candidate as the item value of the extraction target item. Note that the item value extraction unit 48 may compare the appropriateness scores of all the item value candidates to determine the item value candidate having the highest appropriateness score.

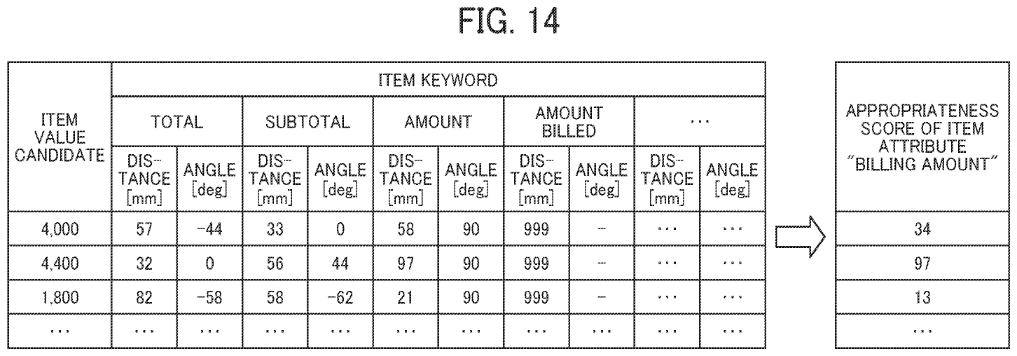

FIG. 14 is a diagram illustrating an example of a positional relationship information list and appropriateness scores for the extraction target image according to the present embodiment. FIG. 14 illustrates a positional relationship information list of positional relationships between a plurality of item value candidates (such as “4,000”, “4,400”, and “1,800”) for the item attribute “billing amount” extracted from the extraction target image and a plurality of item keywords (such as “total”, “subtotal”, “amount”, and “amount billed”) for the item attribute “billing amount”. In response to feature quantities based on the positional relationship information illustrated in FIG. 14 being input to the trained model, a reliability or the like (appropriateness score) of each item value candidate is output from the trained model. As illustrated in FIG. 14, in response to feature quantities of the item value candidates “4,000”, “4,400”, and “1,800” being input to the trained model, the appropriateness scores of the respective item value candidates are calculated to be “34”, “97”, and “13”, respectively. The item value candidate “4,400” having the highest appropriateness score is determined as the item value of the item attribute “billing amount”.

### Process Flow

A flow of a training process performed by the training apparatus 2 according to the present embodiment will be described. Note that the specific processing content and processing order described below are examples for implementing the present disclosure. The specific processing content and processing order may be appropriately selected according to the mode of implementation of the present disclosure.

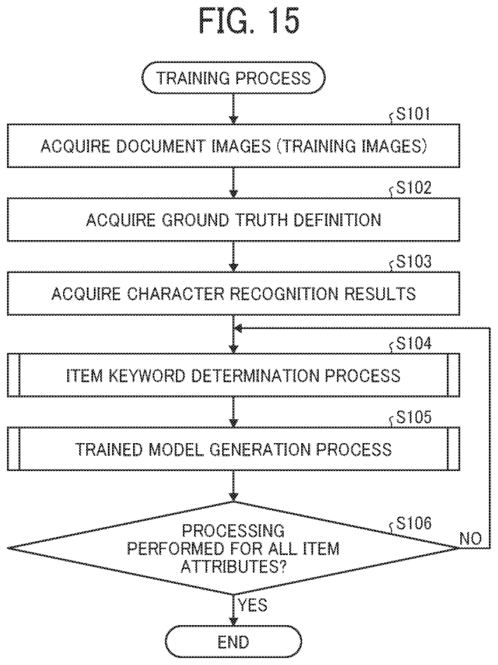

FIG. 15 is a flowchart illustrating an overview of the flow of the training process according to the present embodiment. The process illustrated by this flowchart is performed by the training apparatus 2 in response to a trigger such as receipt of a scan instruction for a form (document). Note that this flowchart may be performed in response to a trigger such as receipt of a user instruction to acquire a form image stored in the storage device 24.

In step S101, the image acquisition unit 51 acquires a plurality of document images (training images). The image acquisition unit 51 acquires scanned images of documents (originals) of a predetermined document type (for example, invoice) having layouts different from one another. The process then proceeds to step S102.

In step S102, the ground truth definition acquisition unit 55 acquires a ground truth definition. The ground truth definition acquisition unit 55 acquires a ground truth definition in which an extraction target item attribute (for example, “billing amount”) of the predetermined document type (for example, invoice) is associated with a ground truth definition value of the item attribute in each training image. The process then proceeds to step S103.

In step S103, the recognition result acquisition unit 52 acquires a character recognition result (full-text OCR result). The recognition result acquisition unit 52 performs character recognition on each of the training images acquired in step S101 to acquire a character recognition result for each of the training images. Note that the order of steps S102 and S103 may be reversed. The order of steps S101 and S102 may also be reversed. The process then proceeds to step S104.

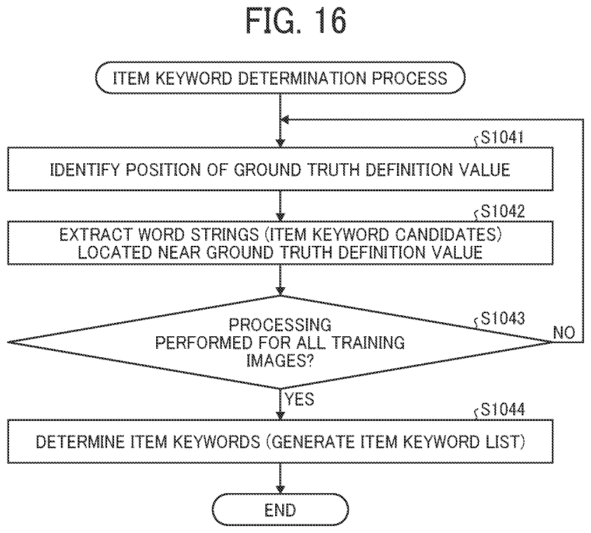

In step S104, an item keyword determination process is performed. In the item keyword determination process, a plurality of item keywords to be used for extracting an item value of one item attribute (for example, “billing amount”) among extraction target item attributes is determined. Details of the item keyword determination process will be described below with reference to FIG. 16. The process then proceeds to step S105.

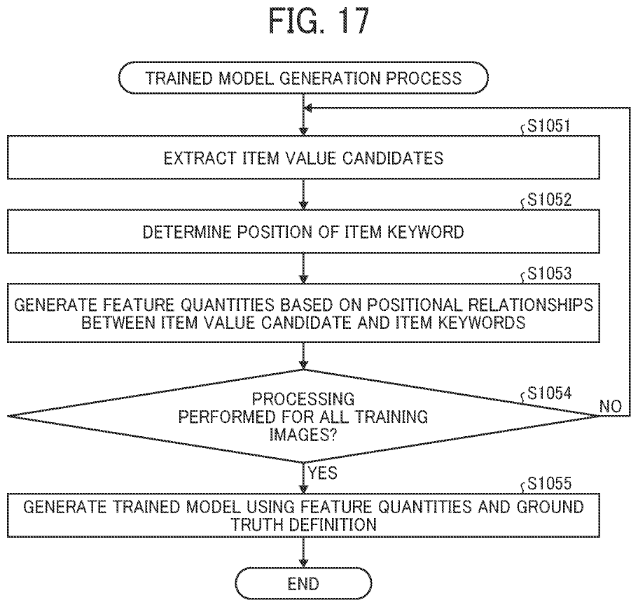

In step S105, a trained model generation process is performed. In the trained model generation process, a trained model for extracting an item value of one item attribute (for example, “billing amount”) among the extraction target item attributes is generated. Details of the trained model generation process will be described below with reference to FIG. 17. The process then proceeds to step S106.

In step S106, it is determined whether the item keyword determination process (step S104) and the trained model generation process (step S105) have been performed for all the extraction target items. The CPU 21 determines whether an item keyword list and a trained model have been generated for each of the extraction target items. Note that all the extraction target items can be checked (recognized) with reference to the ground truth definition. If the processes have not been performed for all the extraction target items (NO in step S106), the process returns to step S104 and the item keyword determination process and the trained model generation process are performed for each extraction target item (for example, the item attribute “payment deadline”) yet to be processed. On the other hand, if the processes have been performed for all the extraction target items (YES in step S106), the process illustrated by this flowchart ends.

FIG. 16 is a flowchart illustrating an overview of the flow of the item keyword determination process according to the present embodiment. The process illustrated by this flowchart is performed in response to a trigger that is the end of step S103 of FIG. 15. Note that this flowchart illustrates a process to be performed in the case where the extraction target item attribute is “billing amount”. Note that the item keyword determination process corresponds to an analysis process to analyze a training image.

In step S1041, a position of a ground truth definition value of an extraction target item is identified in one training image among all the training images. For example, the item keyword determination unit 56 identifies a position where the ground truth definition value “4,059” of the item attribute “billing amount” of the first training image, which is included in the ground truth definition (see FIG. 5), is written in the first training image. The process then proceeds to step S1042.

In step S1042, word strings located near the ground truth definition value of the extraction target item in the one training image among all the training images are extracted as item keyword candidates of the extraction target item. The item keyword determination unit 56 extracts item keyword candidates from the character recognition result of the training image. For example, recognized character strings of character string images located near the ground truth definition value “4,059” whose position in the first training image has been identified in step S1041 are extracted as the item keyword candidates of the item attribute “billing amount” (see FIG. 7). The process then proceeds to step S1043.

In step S1043, it is determined whether the item keyword candidates for the item attribute “billing amount” have been extracted (the processing of steps S1041 and S1042 have been performed) for all the training images. The CPU 21 determines whether the item keyword candidates for the item attribute “billing amount” have been extracted in each of the training images. If the processing has not been performed for all the training images (NO in step S1043), the process returns to step S1041 and the processing is performed for each training image (for example, the second training image) yet to be processed. On the other hand, if the processing has been performed for all the training images (YES in step S1043), the process proceeds to step S1044.

In step S1044, item keywords are determined for the item attribute “billing amount” (an item keyword list is generated). The item keyword determination unit 56 selects a plurality of item keywords for the item attribute “billing amount” from among the item keyword candidates extracted for the item attribute “billing amount” from each training image in step S1042, and generates an item keyword list. The storage unit 59 stores the generated item keyword list. The process illustrated by the flowchart then ends.

FIG. 17 is a flowchart illustrating an overview of the flow of the trained model generation process according to the present embodiment. The process illustrated by this flowchart is performed in response to a trigger that is the end of step S104 of FIG. 15 (the process of FIG. 16). Note that this flowchart also illustrates a process to be performed in the case where the item attribute is “billing amount”.

In step S1051, item value candidates for the extraction target item are extracted from the character recognition result of one training image among all the training images. The item value candidate extraction unit 54 uses the format definition of the extraction target item stored in the format definition storage unit 53 to extract the item value candidates for the extraction target item. For example, the item value candidate extraction unit 54 extracts word strings that match the format definition of the item attribute “billing amount” from the character recognition result of the first training image, as item value candidates for the item attribute “billing amount” in the first training image. The process then proceeds to step S1052.

In step S1052, positions (portions) of the item keywords of the extraction target item are identified in the one training image among all the training images. For example, the feature generation unit 57 searches for a word string that matches an item keyword included in the item keyword list of the item attribute “billing amount” from the character recognition result of the first training image, and identifies the position where the matching word string (item keyword) is written in the first training image. The process then proceeds to step S1053.

In step S1053, feature quantities of an item value candidate are generated based on positional relationships between the item value candidate and the plurality of item keywords in the one training image among all the training images. The feature generation unit 57 uses the position of the item keyword identified in step S1052 to generate feature quantities of each of the item value candidates extracted in step S1051. For example, the feature generation unit 57 generates feature quantities of each item value candidate for the item attribute “billing amount” in the first training image, based on the positional relationships between the item value candidate and the plurality of item keywords of the item attribute “billing amount”. The process then proceeds to step S1054.

In step S1054, it is determined whether the feature quantities of the item value candidate have been generated (the processing of steps S1051 and S1053 has been performed) for all the training images. The CPU 21 determines whether the feature quantities of each item value candidate for the item attribute “billing amount” have been generated for each of the training images. If the processing has not been performed for all the training images (NO in step S1054), the process returns to step S1051 and the processing is performed for each training image (for example, the second training image) yet to be processed. On the other hand, if the processing has been performed for all the training images (YES in step S1054), the process proceeds to step S1055.

In step S1055, a trained model is generated for the extraction target item using the feature quantities and the ground truth definition (indicating whether the item value candidate is the ground truth definition value). The model generation unit 58 uses training data the feature quantities of each item value candidate for the item attribute “billing amount” generated in step S1053 are associated with information indicating whether the item value candidate is the ground truth definition value to generate a trained model for the item attribute “billing amount”. The storage unit 59 stores the generated trained model. The process illustrated by the flowchart then ends.

As described above, a trained model and an item keyword list can be automatically generated just using images of documents of a predetermined document type such as semi-fixed-format forms and ground truth definitions corresponding to the images.

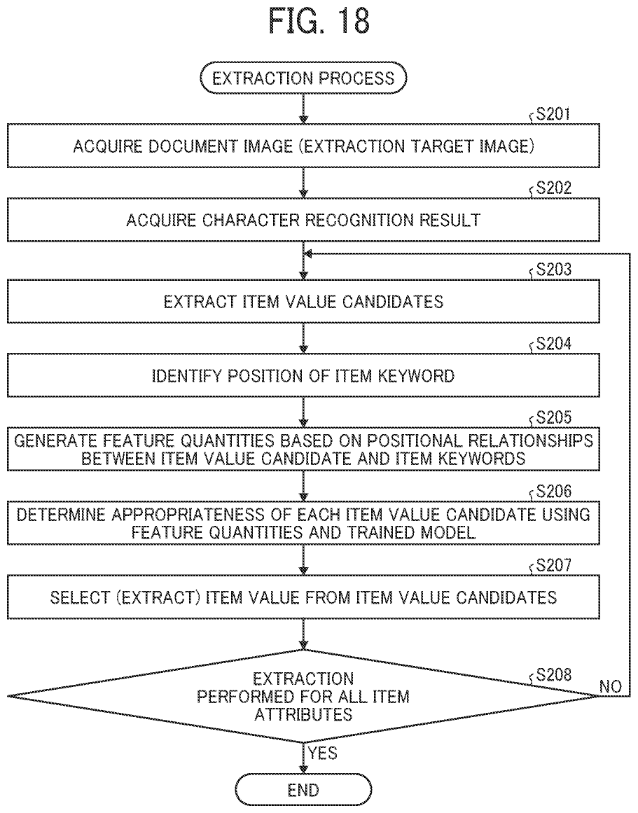

FIG. 18 is a flowchart illustrating an overview of the flow of an extraction process according to the present embodiment. The process illustrated by this flowchart is performed by the information processing apparatus 1 in response to a trigger such as receipt of a scan instruction for a form (document). Note that this flowchart may be performed in response to a trigger such as receipt of a user instruction to acquire a form image stored in the storage device 14. Note that this flowchart also illustrates a process to be performed in the case where the item attribute is “billing amount”.

In step S201, a document image (extraction target image) is acquired. The image acquisition unit 41 acquires a scanned image of a document (original) of a predetermined document type (for example, invoice). The process then proceeds to step S202.

In step S202, a character recognition result (full-text OCR result) is acquired. The recognition result acquisition unit 42 performs character recognition on the extraction target image acquired in step S201, and thus acquires a character recognition result (full-text OCR result) for the extraction target image. The process then proceeds to step S203.

In step S203, item value candidates for the extraction target item are extracted from the character recognition result of the extraction target image. The item value candidate extraction unit 46 extracts word strings that match the format definition of the item attribute “billing amount” stored in the format definition storage unit 45, as item value candidates for the item attribute “billing amount”. The process then proceeds to step S204.

In step S204, the positions (portions) of the item keywords of the extraction target item in the extraction target image are identified. The feature generation unit 47 searches for a word string that matches an item keyword included in the item keyword list of the item attribute “billing amount” from the character recognition result of the extraction target image, and identifies the position where the matching word string (item keyword) is written in the extraction target image. The process then proceeds to step S205.

In step S205, feature quantities of an item value candidate are generated based on positional relationships between the item value candidate and the plurality of item keywords in the extraction target image. The feature generation unit 47 uses the position of the item keyword identified in step S204 to generate feature quantities of each of the item value candidates for the item attribute “billing amount” extracted in step S203. The process then proceeds to step S206.

In step S206, the feature quantities of each item value candidate of the extraction target item and the trained model are used to determine the appropriateness of the item value candidate. The item value extraction unit 48 inputs the feature quantities of each item value candidate for the item attribute “billing amount”, which are generated in step S205, to the trained model for the item attribute “billing amount” stored in the model storage unit 43, and thus determines whether the item value candidate is appropriate as the item value of the item attribute “billing amount”. The item value extraction unit 48 uses the trained model to calculate, for each item value candidate, an appropriateness score indicating a probability of the item value candidate being the item value. The process then proceeds to step S207.

In step S207, an item value candidate that is likely to be the item value of the extraction target item is selected (extracted) based on the appropriateness score. If a single item value candidate is determined to be appropriate as the item value in step S206, the item value extraction unit 48 determines the item value candidate as the item value candidate that is likely to be the item value of the extraction target item (as the item value of the extraction target item). On the other hand, if a plurality of item value candidates are determined to be appropriate as the item value of the extraction target item, the item value extraction unit 48 determines an item value candidate having the highest appropriateness score calculated in step S206 among the plurality of item value candidates, as an item value candidate that is likely to be the item value of the extraction target item (as the item value of the extraction target item).

The item value extraction unit 48 outputs the determined (extracted) item value. This enables automation (semi-automation) of input word of a form in response to input of the item value output by the item value extraction unit 48 to the system, for example. The process then proceeds to step S208.

In step S208, it is determined whether the item value has been extracted for all the extraction target items. The CPU 11 determines whether the item value (likely item value candidate) has been extracted for each extraction target item. Note that all the extraction target items can be checked (recognized) with reference to the ground truth definition. If the item value has not been extracted for all the extraction target items (NO in step S208), the process returns to step S203 and the processing is performed for each extraction target item (for example, the item attribute “payment deadline”) yet to be processed. On the other hand, if the item value has been extracted for all the extraction target items (YES in step S208), the process illustrated by this flowchart ends.

In the present embodiment, the invoice is used as an example of the predetermined document type, and the training process for extracting an item value in an invoice and the extraction process of extracting an item value in an invoice have been described as an example. However, the training process may be performed for each of a plurality of predetermined document types. In such a case, the training apparatus 2 generates, for each of the plurality of predetermined document types (such as an invoice and a statement of delivery, for example), a trained model and an item keyword list for each extraction target item. In this case, the information processing apparatus 1 acquires the trained model and the item keyword list for each document type from the training apparatus 2, and thus can extract the item value from documents (originals) of various document types. Note that the trained model of which document type is to be used for the acquired extraction target image may be determined by a user who visually recognizes the extraction target image (original) or by the information processing apparatus 1 having a function of automatically identifying the document type of the document (original) depicted in the extraction target image.

As described above, an image of a document such as a semi-fixed-format form subjected to extraction and the trained model and the item keyword list are used to perform the extraction process, so that an intended item value can be output.

As described above, in the present embodiment, the training apparatus 2 generates a trained model that determines, from feature quantities based on positional relationships between a character string (item value candidate) in an image and a plurality of item keywords, whether the character string (item value candidate) is an item value of a target item. Thus, the training apparatus 2 can generate a model (extractor) that extracts an item value even from an image of a document in which the written position (layout) of the item is not fixed (layout varies). In the present embodiment, the information processing apparatus 1 uses a trained model that determines, from feature quantities based on positional relationships between a character string (item value candidate) in an image and a plurality of item keywords, whether the character string (item value candidate) is an item value of a target item to determine the appropriateness for each item value candidate in the extraction target image. Thus, the information processing apparatus 1 can extract an item value even from an image (extraction target image) of a document having an unfixed layout.

In the present embodiment, an item value extractor (trained model) that supports an image of a document having an unfixed layout can be easily generated. In the related art, it is desired to automatically extract data (item value) of an item desired by a user from forms of various layouts. The content (item) written in forms are generally in common regardless of issuing companies of the forms but the written position of the item (form layout) is often differs depending on the issuing companies. In this case, the method of defining in advance a position of an item to be read in OCR (of defining a layout) involves making layout definitions for respective form layouts. To handle forms having various layouts, format definitions for as many layouts as the number of business partner companies are to be created, which is not easy.

There is a method called semi-fixed-format form OCR. In this method, keywords for item names corresponding to item values, such as an issuing company name, a payment date, and a billing amount desired to be used, and relative positional relationships between the item value and the item name are manually defined and extracted as an extraction rule. In this method, a worker (skilled person) familiar with forms observes a target semi-fixed-format form, and thus manually create an extraction rule. This method is more general than the method described above. However, finding the extraction rule such as the keywords for the item names and the relative positional relationships involves the knowledge and experience. Thus, it is not easy to handle forms of various layouts.

However, the present embodiment described above involves merely preparation of samples of target forms (a plurality of training images of the same kind of forms having layouts different from one another) and a ground truth definition of an item value to be extracted (information indicating whether an item value candidate is an item value of an extraction target item), and thus a trained model and item keywords that are an alternative to (correspond to) the extraction rule for extracting the item value can be automatically (semi-automatically) created. Accordingly, even a general worker can easily generate an extractor (trained model) that extracts an item value from a semi-fixed-format form. That is, in the present embodiment, an extractor (trained model) that supports a document having an unfixed layout can be generated. The use of this extractor allows an item value to be extracted from a document having an unfixed layout.

During operation, preparing a trained model that supports a document (semi-fixed-format form) having an unfixed layout, item keywords, and an extraction target image enables extraction of the item value from the extraction target image. Thus, the item value can be easily (with reduced labor) extracted from the semi-fixed-format form. In the related art, even a skilled person may cause a contradiction of extraction rules in an attempt to handle various bills and invoices. However, in the present embodiment, since the trained model is generated through machine learning using sample images of various layouts, the item value can be extracted from a semi-fixed-format form with a higher accuracy.

### Other Embodiments

In the embodiment above, the example has been described in which a ground truth definition is generated in response to a user manually inputting a ground truth definition value. However, the generation method of the ground truth definition is not limited to the method described above, and may be a generation method using a tool for assisting generation of a ground truth definition. In the embodiment above, the ground truth definition in the table format has been described. However, the format of the ground truth definition is not limited to the table format such as comma-separated values (CSV) format (CSV file) and may be any other format. In the present embodiment, description will be given of a generation method of a ground truth definition in a CSV format using a tool (ground truth definition generation screen) assisting generation of a ground truth definition.

Note that in a functional configuration of the present embodiment described below, components that coincide with the contents described in the embodiment above are denoted by the same reference signs, and description thereof is omitted. Since a configuration of an information processing system 9 according to the present embodiment is substantially the same as the configuration (FIG. 1) of the information processing system 9 according to the embodiment described above, description thereof is omitted. Note that the training apparatus 2 according to the present embodiment further includes an input device 26, such as a mouse, a keyboard, or a touch panel, and an output device 27 such as a display, in addition to the CPU 21, the ROM 22, the RAM 23, the storage device 24, and the communication unit 25.

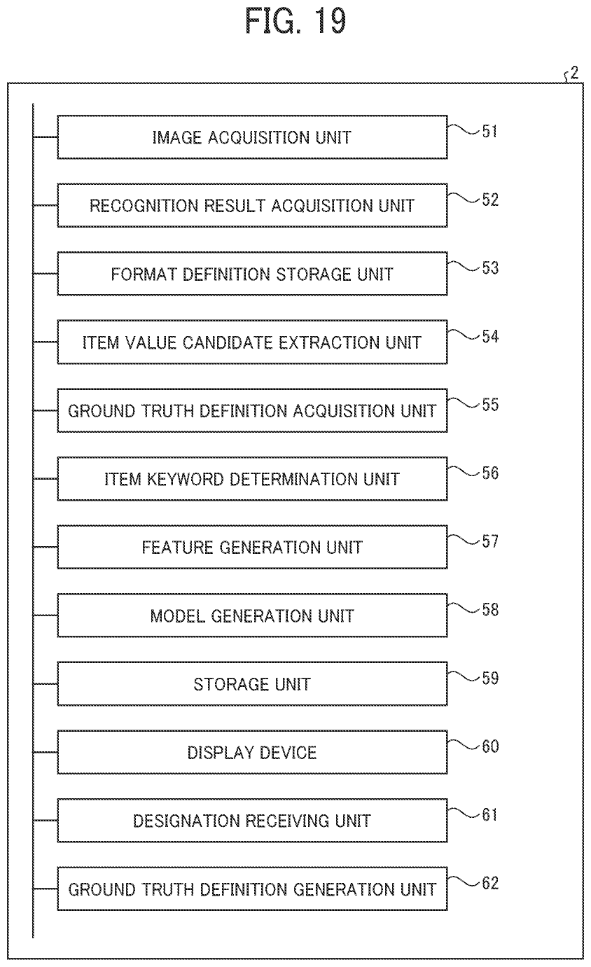

FIG. 19 is a schematic diagram illustrating a functional configuration of the training apparatus according to the present embodiment. The CPU 21 reads a program recorded in the storage device 24 to the RAM 23 and executes the program, so that the pieces of hardware of the training apparatus 2. Consequently, the training apparatus 2 functions as an apparatus further including a display unit 60, a designation receiving unit 61, and a ground truth definition generation unit 62 in addition to the image acquisition unit 51, the recognition result acquisition unit 52, the format definition storage unit 53, the item value candidate extraction unit 54, the ground truth definition acquisition unit 55, the item keyword determination unit 56, the feature generation unit 57, the model generation unit 58, and the storage unit 59. The display unit 60, the designation receiving unit 61, and the ground truth definition generation unit 62 that are differences from the above-described embodiment will be described below.

The display unit 60 performs various display processes via the output device 27 of the training apparatus 2. For example, the display unit 60 generates and displays a ground truth definition generation screen in which a user (worker who generates the ground truth definition) selects an item value (ground truth definition value) of an extraction target item to generate the ground truth definition. The display unit 60 displays, in the ground truth definition generation screen, each training image and displays item value candidates in the displayed training image in a method such as surrounding the item value candidates with red frames, dot-line frames, or the like to allow the user to visually recognize the extracted item value candidates are candidates for the item value. The display unit 60 displays character strings (item value candidates) that are OCR results of areas selected by the user as the ground truth definition values, in a ground truth definition value table that displays the character strings selected as the ground truth definition values. As described above, the display unit 60 is a user interface (UI) (ground truth selection UI) for displaying a training image, extracted item value candidates, and selected ground truth definition values.

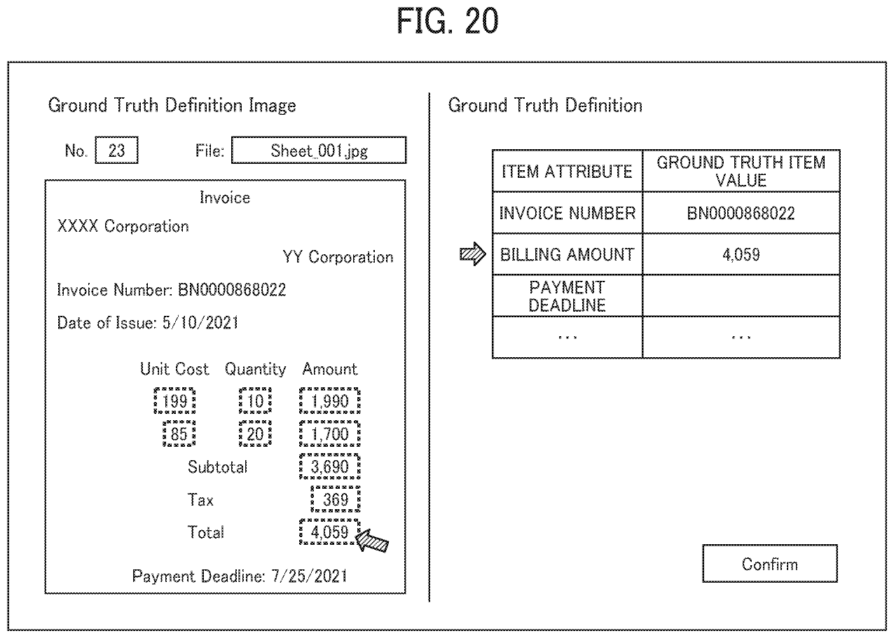

FIG. 20 is a diagram illustrating an example of the ground truth definition generation screen (when “billing amount” is selected) according to the present embodiment. As illustrated in FIG. 20, the ground truth definition generation screen displays a training image (ground truth definition image) subjected to ground truth definition (on the left side in the screen in FIG. 20), and a ground truth definition value table (on the right side in the screen in FIG. 20). Note that the ground truth definition screen is not limited to the screen having the configuration illustrated in FIG. 20, and may have any configuration that displays the ground truth definition image and the item value candidates and that allows selection of a ground truth definition value from the displayed item value candidates.

FIG. 20 illustrates an example in which the ground truth definition value of the item attribute “billing amount” is determined in the first training image. As illustrated in FIG. 20, the item value candidates for the item attribute “billing amount” are displayed with dot-line frames in the ground truth definition generation screen. As described below, the display unit 60 displays, in response to the user selecting the item value candidate “4,059”, “4,059” that is a character string of an OCR result of the selected area in a field of the item attribute “billing amount” in the ground truth definition value table.

At that time, as illustrated in FIG. 20, the display unit 60 may display an arrow or the like for the corresponding item attribute in the ground truth definition value table to make it easier for the user to recognize the target item attribute (billing amount) for which the ground truth definition value is to be determined. The display unit 60 displays, in response to selection (determination) of the ground truth definition value of the item attribute “billing amount”, a screen for extracting the ground truth definition value of the next item attribute (for example, “payment deadline”).

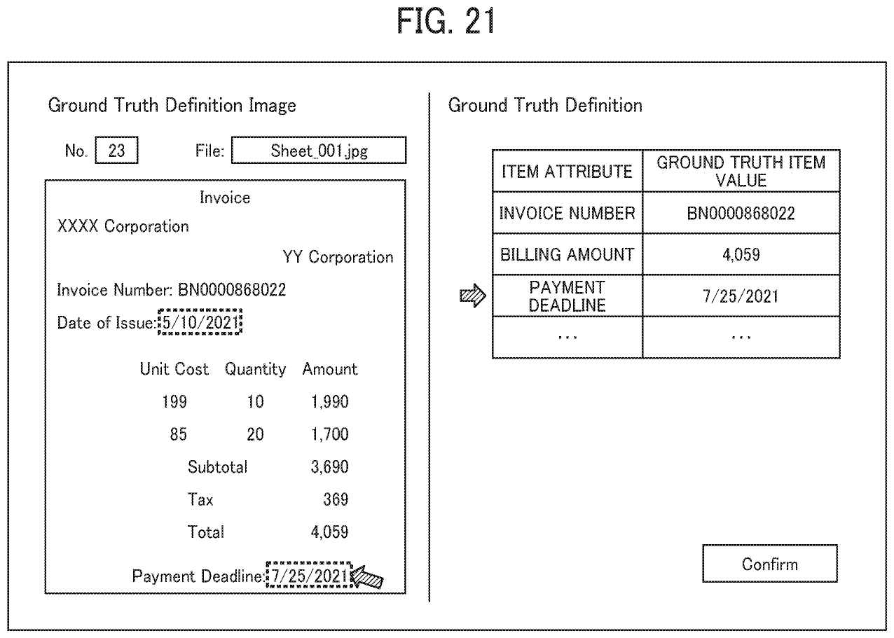

FIG. 21 is a diagram illustrating an example of the ground truth definition generation screen (when “payment deadline” is selected) according to the present embodiment. FIG. 21 illustrates an example in which the ground truth definition value of the item attribute “payment deadline” is determined in the first training image. As illustrated in FIG. 21, the item value candidates for the item attribute “payment deadline” are displayed with dot-line frames in the ground truth definition generation screen. Since the target item attribute is changed from the state in FIG. 20, the focus (arrow) is moved to “payment deadline” which is the target item attribute in the ground truth definition value table as illustrated in FIG. 21. This prompts the user to select the ground truth definition value of the next item attribute.

The designation receiving unit 61 receives various inputs (designations) from the user via the input device 26 such as a mouse. For example, the designation receiving unit 61 receives designation of one item value candidate as the ground truth definition value by the user from among the item value candidates displayed in the ground truth definition generation screen. For example, the designation receiving unit 61 receives designation related to selection of the ground truth definition value related to selection of an item value candidate in response to the user selecting, with a mouse or the like, an item value candidate that is the item value of the extraction target item. In the example of FIG. 20, the user who has visually recognized the item value candidates selects, with the mouse, the item value candidate “4,059” as the ground truth definition value (an area pointed by the arrow (pointer)). Consequently, in the ground truth definition value table, “4,059” which is a character string of the OCR result of the selected area is displayed as the ground truth definition value. In the example of FIG. 21, the item value candidate “7/25/2021” is selected as the ground truth definition value. Consequently, in the ground truth definition value table, “7/25/2021” which is the character string of the OCR result of the selected area is displayed in the ground truth definition value.

The ground truth definition generation unit 62 sets the item value candidate, designated by the user, of the extraction target item (item attribute), i.e., the character string of the OCR result of the designated area, as the item value (ground truth definition value) of the extraction target item in the training image, and thus generates a ground truth definition. The ground truth definition generation unit 62 generates a ground truth definition in which the item value candidate of each extraction target item, for which the designation receiving unit 61 has received designation, is stored as the ground truth definition value. Note that the format of the ground truth definition is not limited to the CSV format, and may be any format. The ground truth definition generation unit 62 outputs the generated ground truth definition. The ground truth definition acquisition unit 55 acquires the ground truth definition generated and output by the ground truth definition generation unit 62.

In the examples of FIGS. 20 and 21, in response to the user selecting the ground truth definition values for all the item attributes and then pressing a “Confirm” button, a ground truth definition that stores the selected item value (ground truth definition value) of each item attribute is generated. Note that the target (extraction target) item attribute for which the item value (ground truth definition value) is defined may be determined by the user in advance and stored as definition target item attribute data in the storage device 24 or the like. The above-described process of determining (selecting) the ground truth definition value is performed for each definition target item attribute included in the definition target item attribute data. Note that in the present embodiment, the training apparatus 2 performs the ground truth definition generation process. However, the configuration is not limited to this, and an apparatus other than the training apparatus 2 may perform the ground truth definition generation process. In such a case, the training apparatus 2 acquires the ground truth definition from the other apparatus that has performed the ground truth definition generation process, and performs the training process.

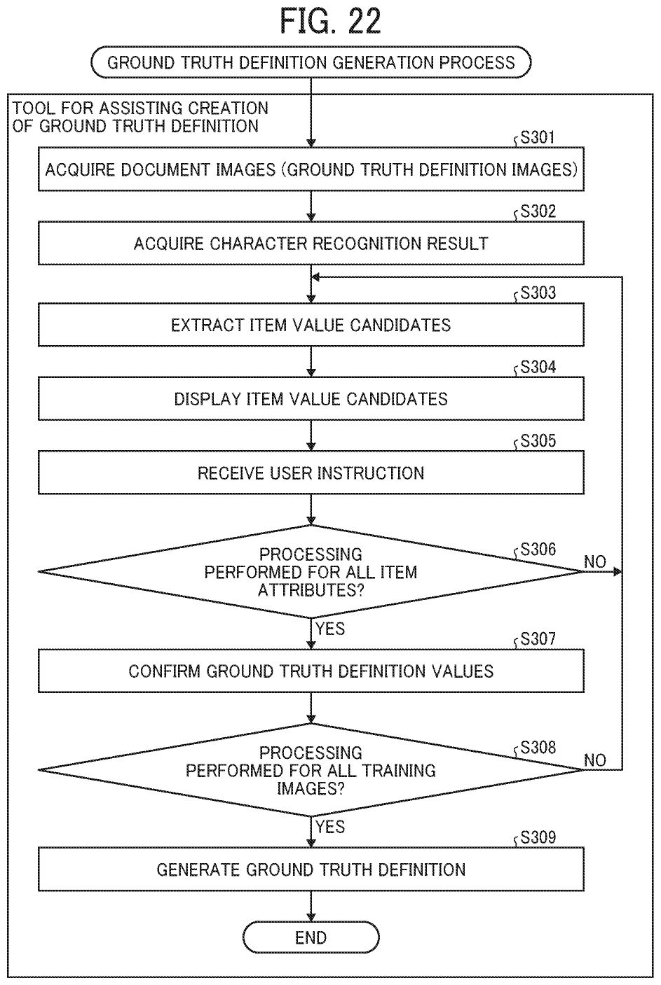

FIG. 22 is a flowchart illustrating an overview of the flow of the ground truth definition generation process according to the present embodiment. The process illustrated by this flowchart is performed in response to a trigger such as receipt of a scan instruction for a form (document) in the ground truth definition generation screen displayed on the training apparatus 2. Note that this flowchart may be performed in response to a trigger such as receipt of a user instruction to acquire a form image stored in the storage device 24. The process illustrated by this flowchart is performed prior to the training process illustrated in FIG. 15 as preprocessing of the training process. Note that this flowchart also illustrates a process to be performed in the case where the item attribute is “billing amount”.

In step S301, a plurality of document images (ground truth definition images that are training images) are acquired. The image acquisition unit 51 acquires scanned images of documents (originals) of a predetermined document type (for example, invoice) having layouts different from one another. The process then proceeds to step S302.

In step S302, a character recognition result (full-text OCR result) is obtained. The recognition result acquisition unit 52 performs character recognition on each ground truth definition image acquired in step S301, and thus acquires a character recognition result (full-text OCR result) for each ground truth definition image. The process then proceeds to step S303.

In step S303, item value candidates for the extraction target item attribute are extracted from the character recognition result of the ground truth definition image. The item value candidate extraction unit 54 uses the format definition of the extraction target item stored in the format definition storage unit 53 to extract the item value candidates for the extraction target item. For example, the item value candidate extraction unit 54 extracts word strings that match the format definition of the item attribute “billing amount” from the character recognition result of the first training image, as item value candidates for the item attribute “billing amount” in the first training image. The process then proceeds to step S304.

In step S304, the item value candidates are displayed in the ground truth definition generation screen. The display unit 60 displays, in the ground truth definition generation screen, the item value candidates to allow the user to recognize which word string the item value candidate extracted in step S303 is (see FIG. 20). The process then proceeds to step S305.

In step S305, designation of the ground truth definition value is received from the user. The designation receiving unit 61 receives designation of the ground truth definition value by the user. In the example of FIG. 20, the item value candidate “4,059” which is the item value of the item attribute “billing amount” in the first training image is designated as the ground truth definition value by the user. Thus, designation of the ground truth definition value is received. In response to the user selecting the ground truth definition value, the display unit 60 displays, as the ground truth definition value, the character string “4,059” which is the OCR result of the selected area in the ground truth definition value table of the ground truth definition generation screen. The process then proceeds to step S306.

In step S306, it is determined whether designation of the ground truth definition value has been received (the processing of steps S303 to S305 has been performed) for all the extraction target items (item attributes). The CPU 21 determines whether designation of the ground truth definition value has been received for each extraction target item. If the processing has not been performed for all the extraction target items (NO in step S306), the process returns to step S303 and the processing is performed for each extraction target item (for example, the item attribute “payment deadline”) yet to be processed. On the other hand, if the processing has been performed for all the extraction target items (YES in step S306), the process proceeds to step S307.

In step S307, the ground truth definition value of each extraction target item (item attribute) in the training image is confirmed. The designation receiving unit 61 receives a user instruction to confirm, as the ground truth definition values, the item value candidates designated for all the item attributes in step S305. The ground truth definition generation unit 62 then confirms the ground truth definition value of each item attribute in the training image (for example, the first training image). The process then proceeds to step S308.

In step S308, it is determined whether the ground truth definition value have been confirmed for all the training images. The CPU 21 determines whether the ground truth definition value of each extraction target item (item attribute) has been confirmed in each of the training images. If the confirmation has not been made for all the training images (NO in step S308), the process returns to step S303, and the ground truth definition generation screen for the training image (for example, the second training image) yet to be processed is displayed and the following processing is performed. On the other hand, if the confirmation has been made for all the training images (YES in step S308), the process proceeds to step S309.

In step S309, the ground truth definition is generated. The ground truth definition generation unit 62 generates a ground truth definition that stores the ground truth definition value confirmed in step S307 for each item attribute for all the training images, and outputs the ground truth definition. The process illustrated by the flowchart then ends. Note that the ground truth definition acquisition unit 55 acquires the ground truth definition from the ground truth definition generation unit 62 (in step S102 of FIG. 15).

Note that in the present embodiment, the training apparatus 2 acquires the training images and the character recognition results of the training images in the ground truth definition generation process. Thus, the processing of steps S101 and S103 of the training process of FIG. 15 performed by the training apparatus 2 may be omitted. In the ground truth definition generation process, the training apparatus 2 extracts the item value candidates. Thus, the processing of step S1051 of the trained model generation process of FIG. 17 performed by the training apparatus 2 may be omitted. In the present embodiment, a plurality of ground truth definition images are collectively acquired in step S301. However, the configuration is not limited to this, and the processing of steps S301 to S307 may be performed for each ground truth definition image.

As described above, in the present embodiment, the automatically extracted item value candidates are displayed. This allows the worker to generate the ground truth definition by just selecting a ground truth item value from among the displayed item value candidates, and thus can increase the efficiency of the work of generating the ground truth definition as compared with the method in which the worker manually inputs the ground truth definition value. This therefore can increase the efficiency of the work for extracting the item value (work for generating the trained model and the item keyword list).

According to the embodiments of the present disclosure, the item value can be extracted even from a document image of a document having an unfixed layout.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), general purpose circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality.

The present disclosure can be understood as an information processing apparatus, a system, and a computer; a method executed by an information processing apparatus, a system, or a computer; or a program executed by a computer. Further, the present disclosure can also be understood as a recording medium that stores such a program and that can be read by, for example, a computer or any other apparatus or machine. The recording medium that can be read by, for example, the computer refers to a recording medium that can store information such as data or programs by electrical, magnetic, optical, mechanical, or chemical action, and that can be read by, for example, a computer.

According to one embodiment, a program executes following functions. The following functions include
recognition result acquisition means to acquire a character recognition result that is a result of character recognition performed on a target image;
item value item value candidate extraction means to extract, from the character recognition result of the target image, a plurality of candidate character strings that are possible character strings of an item value of an extraction target item;
feature generation means to generate, for each of the plurality of candidate character strings, a feature quantity based on positional relationships between the candidate character string and a plurality of item keywords in the target image, the plurality of item keywords being keyword word strings for use in extraction of the item value of the extraction target item;
model storage means to store a trained model that is generated through machine learning to output, in response to input of the feature quantity based on positional relationships between a character string and the plurality of item keywords in an image, information indicating appropriateness of the character string being the item value of the extraction target item; and
item value extraction means to input the feature quantity of each candidate character string in the target image to the trained model, to extract the item value of the extraction target item from among the plurality of candidate character strings.

According to one embodiment, a program executes following functions. The following functions include
recognition result acquisition means to acquire a character recognition result that is a result of character recognition performed on a plurality of training images of documents having layouts different from one another;
feature generation means to generate, for each of character strings included in each of the plurality of training images, the character strings including a character string that is an item value of an extraction target item and other character strings, a feature quantity based on positional relationships between the character string and a plurality of item keywords in the training image, the plurality of item keywords being keyword word strings for use in extraction of the item value of the extraction target item; and
model generation means to generate a trained model through machine learning, the machine learning being performed using training data in which, for each of the character strings included in each of the plurality of training images, the feature quantity of the character string is associated with information indicating whether the character string is the item value of the extraction target item.

1. An information processing system comprising:
circuitry configured to:
acquire a character recognition result that is a result of character recognition performed on a target image;
extract, from the character recognition result of the target image, a plurality of candidate character strings that are candidates of an item value of an extraction target item;
generate, for each of the plurality of candidate character strings, a feature quantity based on positional relationships between the candidate character string and a plurality of item keywords in the target image, the plurality of item keywords being keyword word strings for use in extraction of the item value of the extraction target item;
store a trained model in a memory, the trained model being generated through machine learning such that, in response to input of a feature quantity based on positional relationships between a character string and the plurality of item keywords in an image, information indicating appropriateness of the character string being the item value of the extraction target item is output; and
input the feature quantity of each of the plurality of candidate character strings in the target image to the trained model so as to extract the item value of the extraction target item from among the plurality of candidate character strings.

2. The information processing system of claim 1, wherein the trained model is generated through machine learning using training data,
the training data associating, for each of a plurality of training images of documents having layouts different from one another, a feature quantity based on positional relationships between a candidate character string and a plurality of item keywords in the training image with information indicating whether the candidate character string is the item value of the extraction target item.

3. The information processing system of claim 1, wherein the feature quantity includes, for each of the plurality of item keywords,
a feature quantity based on information indicating a distance between the target character string and the item keyword, and
a feature quantity based on information indicating a direction from one of the target character string and the item keyword toward another one of the target character string and the item keyword.

4. The information processing system according to claim 3, wherein the feature quantity based on the information indicating the distance increases or decreases according to the distance between the target character string and the item keyword.

5. The information processing system according to claim 3, wherein the feature quantity based on the information indicating the direction increases or decreases according to a degree at which the item keyword is located in a horizontal left direction of the target character string and a degree at which the item keyword is located in a vertical above direction of the target character string.

6. The information processing system of claim 1, wherein the circuitry is configured to extract the item value of the extraction target item, based on information indicating a probability of each of the plurality of candidate character strings being the item value of the extraction target item,
the information indicating the probability being output from the trained model in response to input of the feature quantity of each of the plurality of candidate character strings in the target image.

7. The information processing system of claim 1, wherein the plurality of item keywords are word strings determined from among word strings included in at least one training image among a plurality of training images used in the machine learning, based on an attribute of each of the word strings.

8. The information processing system of claim 7, wherein the attribute of each of the word strings includes an appearance frequency of the word string in the plurality of training images.

9. The information processing system of claim 7, wherein the attribute of each of the word strings includes a distance between the word string and the item value of the extraction target item in at least one of the plurality of training images that includes the word string.

10. The information processing system of claim 7, wherein the attribute of each of the word strings includes a direction from one of the word string and the item value of the extraction target item toward another one of the word string and the item value of the extraction target item in at least one of the plurality of training images including the word string.

11. The information processing system of claim 10, wherein the plurality of item keyword are determined based on a degree at which the word string is located in a horizontal left direction or vertical above direction of the item value of the extraction target item.

12. The information processing system of claim 7, wherein the word strings are determined as the plurality of item keywords in descending order of effectiveness scores each indicating effectiveness of the word string based on the attribute of the word string.

13. The information processing system of claim 1, wherein the circuitry is configured to:
store a format definition of the extraction target item in a memory; and
extract character strings that match the format definition of the extraction target item, as the plurality of candidate character strings.

14. An information processing system comprising:
circuitry configured to:
acquire a character recognition result that is a result of character recognition performed on a plurality of training images of documents having layouts different from one another;
generate, for each of character strings included in each of the plurality of training images, the character strings including a character string that is an item value of an extraction target item and other character strings, a feature quantity based on positional relationships between the character string and a plurality of item keywords in the training image, the plurality of item keywords being keyword word strings for use in extraction of the item value of the extraction target item; and
generate a trained model through machine learning, the machine learning being performed using training data,
the training data associating, for each of the character strings included in each of the plurality of training images, the feature quantity of the character string with information indicating whether the character string is the item value of the extraction target item.

15. The information processing system of claim 14, wherein
the circuitry is configured to extract, from the character recognition result of each of the plurality of training images, a plurality of candidate character strings that are candidates of the item value of the extraction target item,
the plurality of candidate character strings that are extracted being the character string that is the item value of the extraction target item and the other character strings.

16. The information processing system of claim 14, wherein the circuitry is configured to:
acquire a ground truth definition, the ground truth definition associating the extraction target item with the item value of the extraction target item in each of the plurality of training images; and
acquire information indicating whether the character string is the item value of the extraction target item, based on the ground truth definition.

17. The information processing system of claim 16, wherein the circuitry is configured to:
display the plurality of candidate character strings extracted for the extraction target item from the character recognition result of each of the plurality of training images, in a method that allows a user to visually recognize that the candidate character strings are candidates for the item value;
receive designation of one candidate character string from among the displayed candidate character strings by the user;
generate the ground truth definition using the designated one candidate character string as the item value of the extraction target item in the training image; and
acquire the generated ground truth definition.

18. An item value extraction method comprising:
acquiring a character recognition result that is a result of character recognition performed on a target image;
extracting, from the character recognition result of the target image, a plurality of candidate character strings that are candidates of an item value of an extraction target item;
generating, for each of the plurality of candidate character strings, a feature quantity based on positional relationships between the candidate character string and a plurality of item keywords in the target image, the plurality of item keywords being keyword word strings for use in extraction of the item value of the extraction target item;
storing a trained model in a memory, the trained model being generated through machine learning such that, in response to input of a feature quantity based on positional relationships between a character string and the plurality of item keywords in an image, information indicating appropriateness of the character string being the item value of the extraction target item is output; and
inputting the feature quantity of each of the plurality of candidate character strings in the target image to the trained model so as to extract the item value of the extraction target item from among the plurality of candidate character strings.

19. A model generation method comprising:
acquiring a character recognition result that is a result of character recognition performed on a plurality of training images of documents having layouts different from one another;
generating, for each of character strings included in each of the plurality of training images, the character strings including a character string that is an item value of an extraction target item and other character strings, a feature quantity based on positional relationships between the character string and a plurality of item keywords in the training image, the plurality of item keywords being keyword word strings for use in extraction of the item value of the extraction target item; and
generating a trained model through machine learning, the machine learning being performed using training data,
the training data associating, for each of the character strings included in each of the plurality of training images, the feature quantity of the character string with information indicating whether the character string is the item value of the extraction target item.
